(19) United States
(12) Patent Application Publication
(10) Pub. No.: US 2016/0320948 A1
(43) Pub. Date: Nov. 3, 2016

(54) DOCUMENT AND OBJECT MANIPULATION

(71) Applicant: ATTACHE SOFTWARE AUSTRALIA PTY LIMITED, Macquarie Park, NSW (AU)

(72) Inventor: Roderick Stuart McLeod, Macquarie Park (AU)

(21) Appl. No.: 15/107,059

(22) PCT Filed: Jan. 6, 2015
(86) PCT No.: PCT/AU2015/000002

§ 371 Date: Jun. 21, 2016

(30) Foreign Application Priority Data
Jan. 7, 2014 (AU) 2014900039

(51) Int. Cl. G06F 3/0484; H04L 29/06; G06F 17/30; G06F 3/0482

(52) U.S. Cl. CPC G06F 3/04842; G06F 3/0482; H04L 63/10; G06F 17/30011

(57) ABSTRACT

A system for manipulation of an object-based document by a user at a client device has at least one server computer (177) and a client device (101). The server computer comprises: a library of predefined executable functions (206); a database (204) for storage of objects associated with the document; a guard application (202) executable to apply at least one access permission to at least part of the document, the access permission being associated with a creator of the document; and a server application (133B) executable to: receive a message call from the client device; select at least one executable function from the library associated with the message call; and communicate the at least one executable function to the client device. The system further comprises a manipulation application (133A) executable persistently in association with a graphical user interface (GUI) application executable on the client device, by which an initial representation of the object-based document is formed in a graphical user interface (GUI) of the GUI application, the manipulation application comprising: a detection process (212) configured to: detect an operation of the user in association with an object of the initial representation via the GUI; select at least one message from a plurality of predefined messages in response to the detected user operation; and communicate the at least one message as a message call to the server computer; and a manipulation process (214) configured to: execute the at least one executable function to manipulate at least one of content or presentation of the object of the initial representation to form an updated representation associated with a corresponding updated object-based document; and storing the updated document at least at the client device for further access by the user; and subject to a relationship defined by the access permission between the user and the creator, storing the updated document at the at least one server, with the objects of the document being stored in the database, for access by at least one of the user and the creator.

### RELATED APPLICATIONS

The present application claims priority from Australian Provisional Patent Application No. 2014900039, filed on 7 Jan. 2014, the contents of which are incorporated herein in their entirety.

### TECHNICAL FIELD

The present invention relates generally to manipulation of electronic documents and software objects.

### BACKGROUND

Use of electronic devices and documents in everyday business and personal tasks is increasingly standard. In order to manipulate electronic documents, a user of an electronic device normally must have a specific document-related application installed on the electronic device. Additionally, the user may require specific training in using that document-related application to manipulate the desired document. If the user receives an electronic document, e.g., by email, the user's electronic device must have an application compatible with the received document type installed in order to display the received document correctly.

The range of popular electronic devices currently in use is diverse and growing. Common electronic devices include desktop computers, laptops, notebooks, tablet devices, smartphones, and the like. The number of associated operating systems or platforms is also varied. The popularity of portable devices is also high. Many workplaces or consumers use more than one type of device. Often, different types of devices require a device-specific, or platform-specific, version of the relevant document-related application. For example a tablet may require an application version that is specific to the operating system of the tablet, rather than a version of the application compatible with the operating system of a desktop computer. Requiring different versions of applications for different devices may be frustrating and/or expensive to a person wishing to reproduce or manipulate the document.

Cloud computing and associated online applications provide some document manipulation tools. However, many consumers, in particular businesses, are unwilling to store important or confidential documents on a generic cloud system.

Further, many applications related to manipulation and/or reproduction of documents, whether cloud-based or not, are provided with constrained format menus. Such menus may be fixed, and thereby provide limited manipulation ability, or require application-specific specialised knowledge of where to find required functionality. Such can be often frustrating and/or time-consuming to a user. Further, unless the correct version of the application is used for the relevant electronic device, a document may not reproduce properly between one device and another. As regular updates are often needed for different applications, or are developed for different devices at different times, placement of menus may be changed between device-specific applications. Navigating and using menus may thus be more difficult, and manipulation of documents time-consuming and frustrating to a user.

These problems are exacerbated when novice users of computers are confronted with a variety of applications, each with their own specific user interface and modes of operation.

A need exists to address these problems of document manipulation.

### SUMMARY

According to a first aspect of the present disclosure, there is provided a system for manipulation of an object-based document by a user at a client device, said system comprising: at least one server computer comprising: a library of predefined executable functions; a database for storage of objects associated with the document; a guard application executable to apply at least one access permission to at least part of the document, the at least one access permission being associated with a creator of the document; and a server application executable to: receive a message call from the client device; select at least one executable function from the library associated with the message call; and communicate the at least one executable function to the client device; a manipulation application executable persistently in association with a graphical user interface (GUI) application executable on the client device, by which an initial representation of the object-based document is formed in a graphical user interface of the GUI application, the manipulation application comprising: a detection process configured to: detect an operation of the user in association with an object of the initial representation via the GUI; select at least one message from a plurality of predefined messages in response to the detected user operation; and communicate the at least one message as a message call to the at least one server computer; and a manipulation process configured to: execute the at least one executable function to manipulate at least one of content or presentation of the object of the initial representation to form an updated representation associated with a corresponding updated object-based document; and store the updated document at least at the client device for further access by the user; and subject to a relationship defined by the at least one access permission between the user and the creator, store the updated document at the at least one server computer, with the objects of the document being stored in the database, for access by at least one of the creator and the user.

A further aspect of the present disclosure provides for manipulation of objects by a user at a client device, said system comprising: at least one server computer comprising: a library of predefined executable functions; a database for storage of objects; a guard application executable to apply at least one access permission to at least the object, the at least one access permission being associated with a creator of the object; and a server application executable to: receive a message call from the client device associated with the object; select at least one executable function from the library associated with the message call; and communicate the selected at least one executable function to the client device; a manipulation application executable in association with a graphical user interface (GUI) application executable on the client device, by which an initial representation of at least one object is formed in a graphical user interface of the GUI application, the manipulation application comprising: a detection process configured to: detect an operation of the user in association with an object of the initial representation via the GUI; select at least one message from a plurality of predefined messages in response to the detected user operation; and communicate the at least one message as a message call to the at least one server computer; and a manipulation process configured to: execute the at least one executable function to manipulate at least one of content or presentation of the object to form an updated representation of the object; and subject to a relationship defined by the at least one access permission between the user and the creator, store the updated object at the at least one server computer, the updated object being stored in the database, for access by at least one of the user and the creator

Other aspects are also disclosed.

### BRIEF DESCRIPTION OF THE DRAWINGS

At least one embodiment of the present invention will now be described with reference to the drawings, in which:

FIG. 1A forms a schematic block diagram of a general networked computer system upon which arrangements described can be practiced;

FIG. 1B forms a schematic block diagram of a general purpose computer system upon which arrangements described can be practiced;

FIG. 2A is a block diagram of a system for manipulating a document of object;

FIG. 2B shows application of different protocols in the system of FIG. 2A;

FIGS. 3A-3D show the process of manipulating a document according to the present disclosure;

FIGS. 4A-4G show a sequence of GUI windows during which a user manipulates a blank document according to the present disclosure;

FIGS. 5A-5C show tabular representations of objects associated with the document of FIGS. 4A-4G;

FIGS. 6A-6C show a sequence of browser windows during which a user manipulates a webpage document created by another users according to the present disclosure;

FIGS. 7A-7B show hierarchical structure of objects according to the present disclosure;

FIGS. 8A and 8B show a list of predefined messages according to the present disclosure; and

FIGS. 9A-9E show sample menus for manipulation of a document or object.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

Creation, manipulation, or reproduction of electronic documents usually requires installation and execution of the specific software application on electronic user device, such as a user computer, tablet, or the like. Additionally, application-specific skills may be required. An electronic document may include a document such as a website, correspondence, invoices, spreadsheets, brochures, diagrams, presentation slides, and the like. Known applications include those of the Microsoft Office™ suite and the like. The majority of these applications require at least application-specific training or background. Manipulation of some documents, such as websites, often requires use of professional skills, increasing cost to the document owner or user.

Cloud-computing based applications such as Google Docs™ are generally modeled to operate in a similar manner to known word-processing and document creation tools, providing similarly fixed menus. For example, the toolbar for Google Docs™ is similar to that of Microsoft Word™.

The systems and methods described herein allow a user to create and/or manipulate electronic documents, and software objects associated with electronic documents without requiring specific skills other than those of a standard computer user.

### Computer System Overview

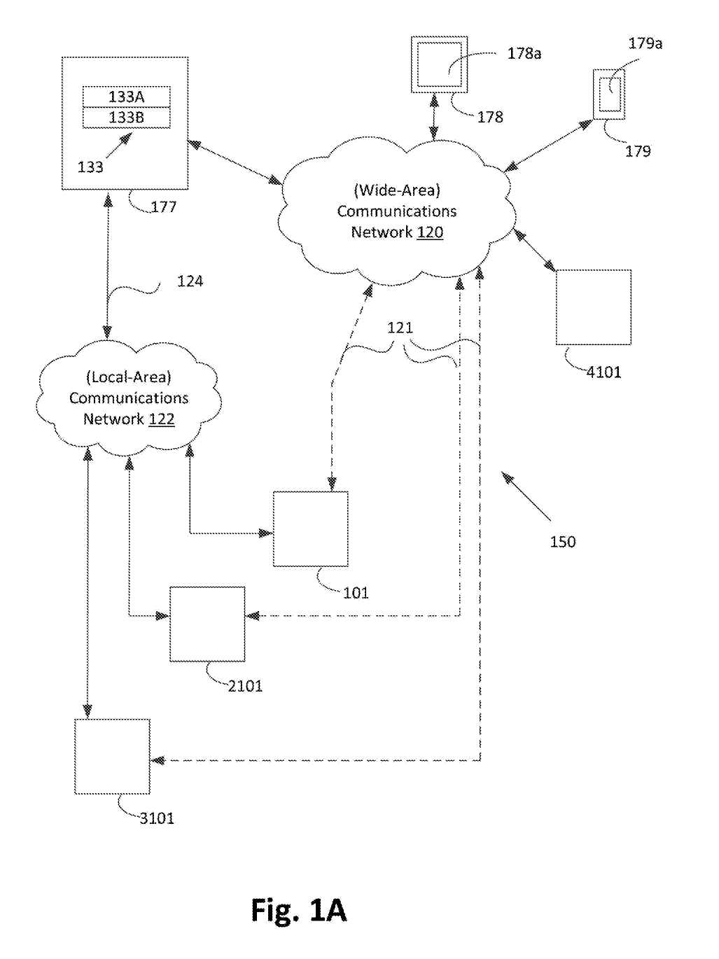

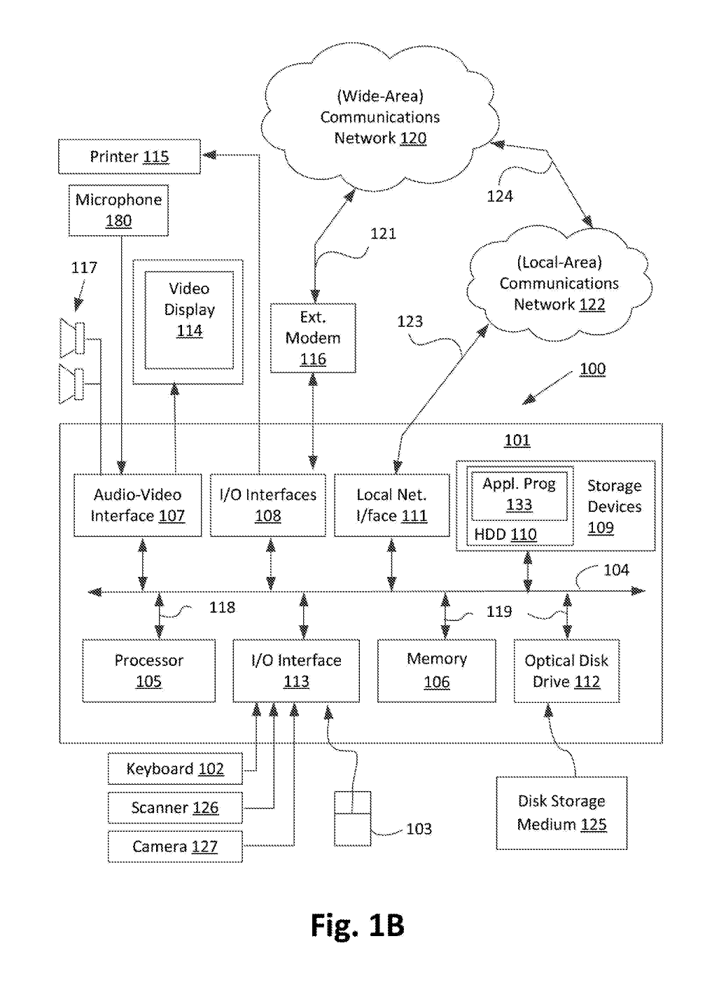

FIG. 1A depicts an exemplary computer network 150, of a type upon which the various arrangements described herein can be practiced.

As seen in FIG. 1A, the network computer system 150 includes a server computer 177 connected to a wide area communications network 120 and a local-area communications network 122. The server computer 177 is interconnected by the local area network 122 to a plurality of user computers or devices 101, 2101, and 3101. In this manner, the user computers 101, 2101 and 3101 and network 122 may form a private network, such as a company intranet. Additionally and/or alternatively, the server 177 may be connected to the user devices 101-3101 by the wide area communications network 120, as indicated in broken lines. The server 177 is also shown connected to further client devices, such as a tablet 178, a smartphone 179, and a computer, e.g., such as laptop computer, 4101, via the wide area connection 120.

FIG. 1B depicts a general-purpose computer system 100, providing an example of the operational architecture of the devices (101, 2101, 3101, 4101, 178, 179) shown in FIG. 1A.

As shown in FIG. 1B, the computer system 100 includes: a computer module 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from the communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

Portable devices may differ somewhat in implementation of input and output device means. For example, the tablet 178 includes a screen 178a, and the smartphone 179 includes a screen 179a. The screens 178a and 179a operate to provide the functionality of the display 114, and as touch screens, effectively providing functionality of the mouse device 103.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems.

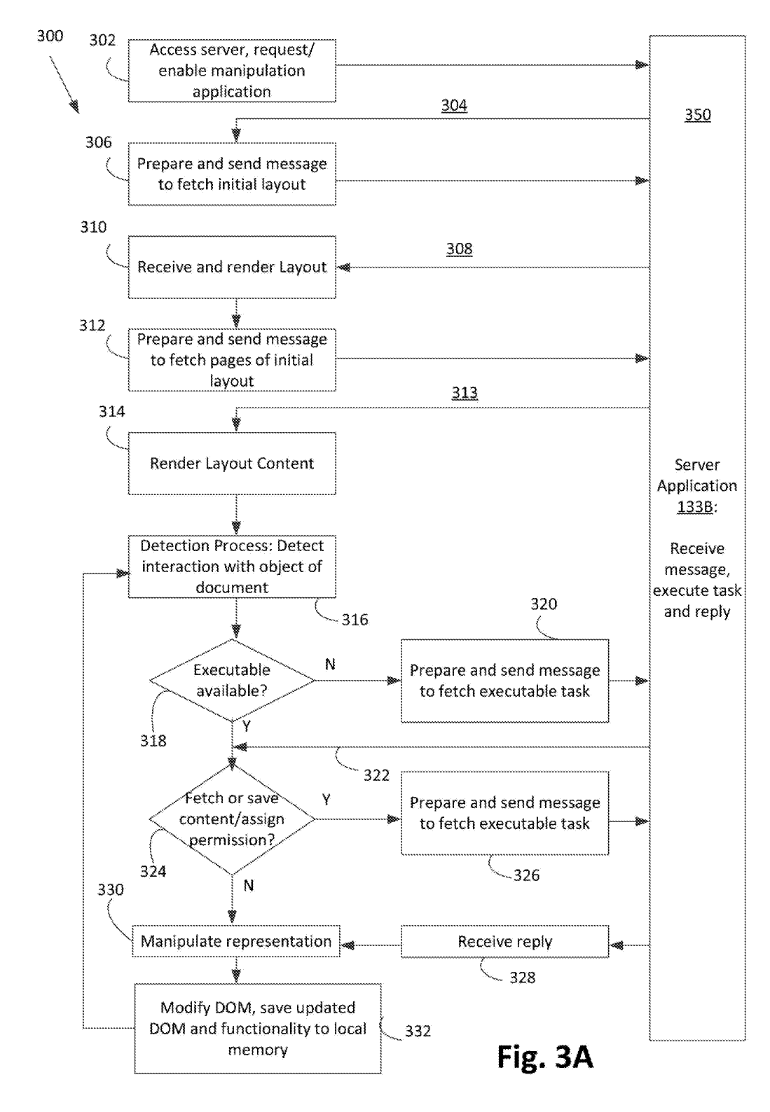

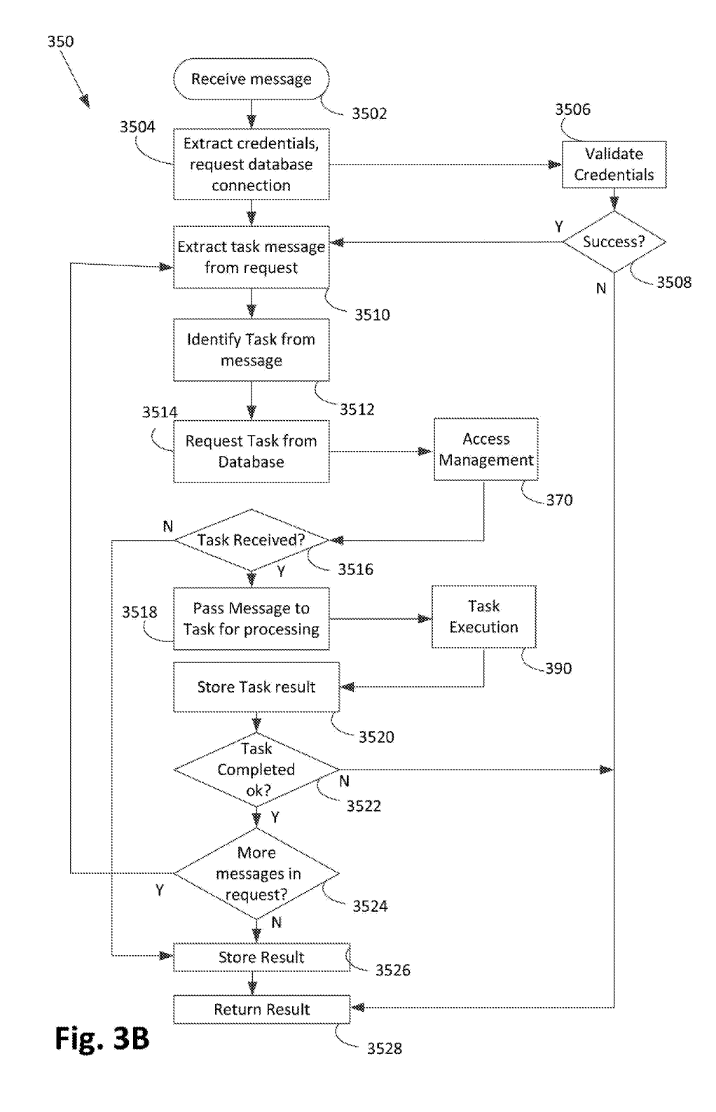

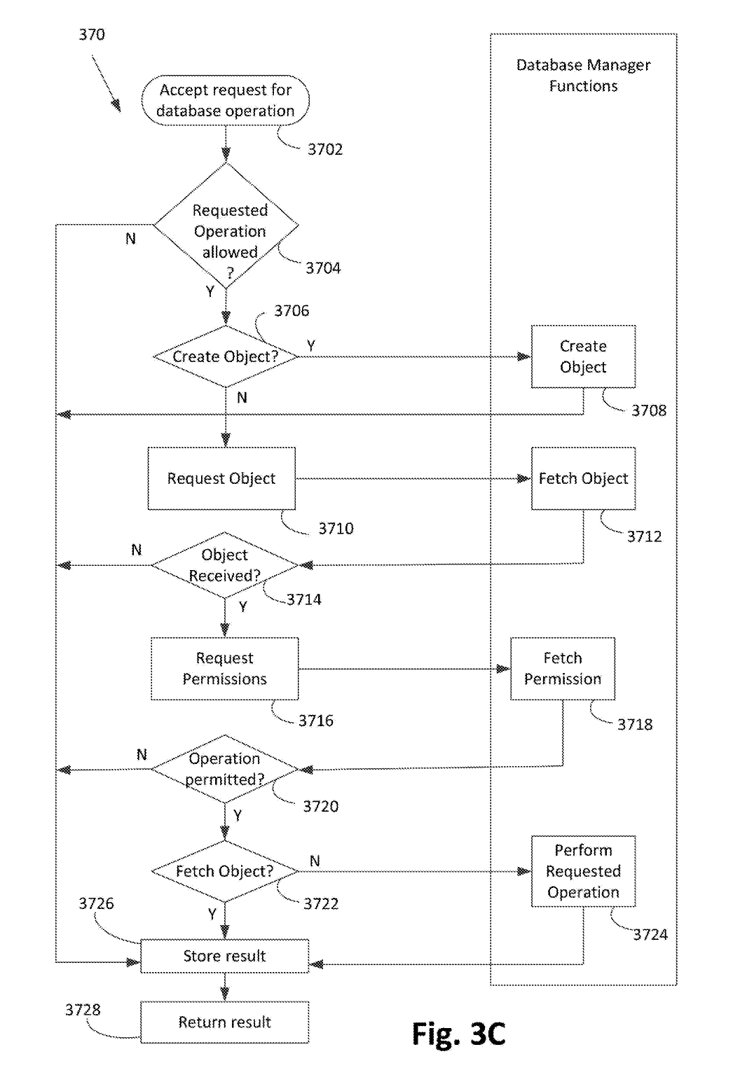

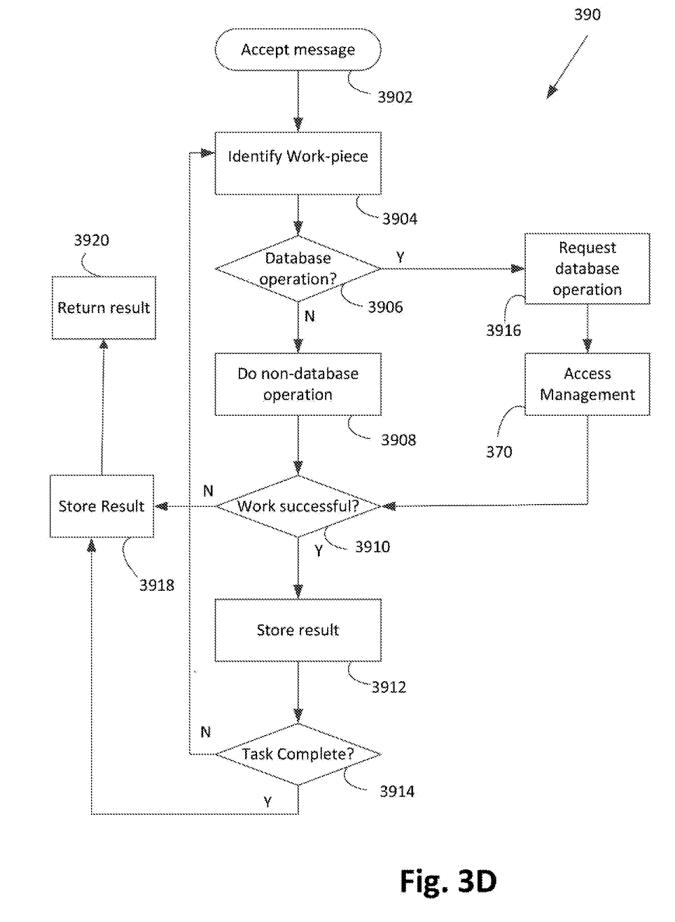

The method of FIGS. 3A-3D may be implemented using the computer system 100 wherein the processes of FIGS. 3A-3D, to be described, may be implemented as one or more software application programs 133 executable within the computer system 100. In particular, the steps of the method of FIGS. 3A-3D are in the software application 133 that are carried out within the computer system 100. The software application 133 may be formed as one or more code modules, each for performing one or more particular tasks. The software may also be divided into two separate parts, in which a first part and the corresponding code modules performs the server-side functions and a second part and client-side functions. An application 133 installed on the server 177 of FIG. 1A comprises two parts, 133A and 133B, for use in manipulation of documents and objects, as described hereafter.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for document and object manipulation.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for document and object manipulation.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

In the description hereafter, the module 101 is used in as an example client device. However, this description applies equally to all types of client devices, and in some instances the server 177 and client device 101 may be the same computing device.

### Document and Object Manipulation System

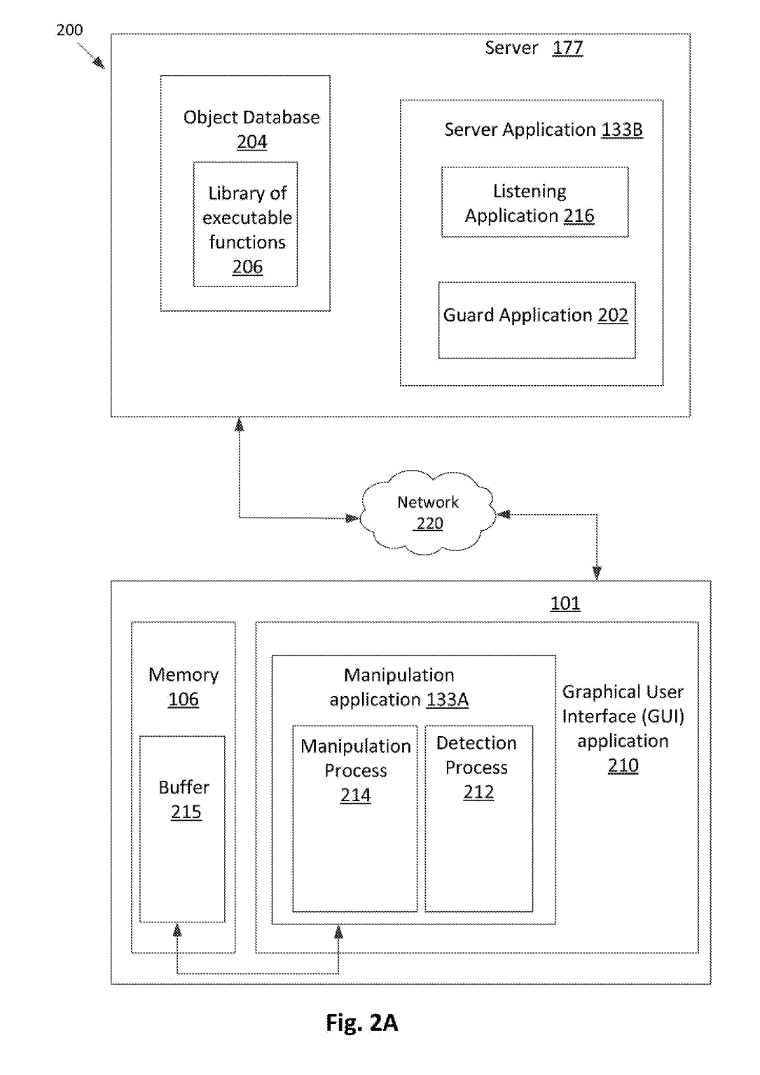

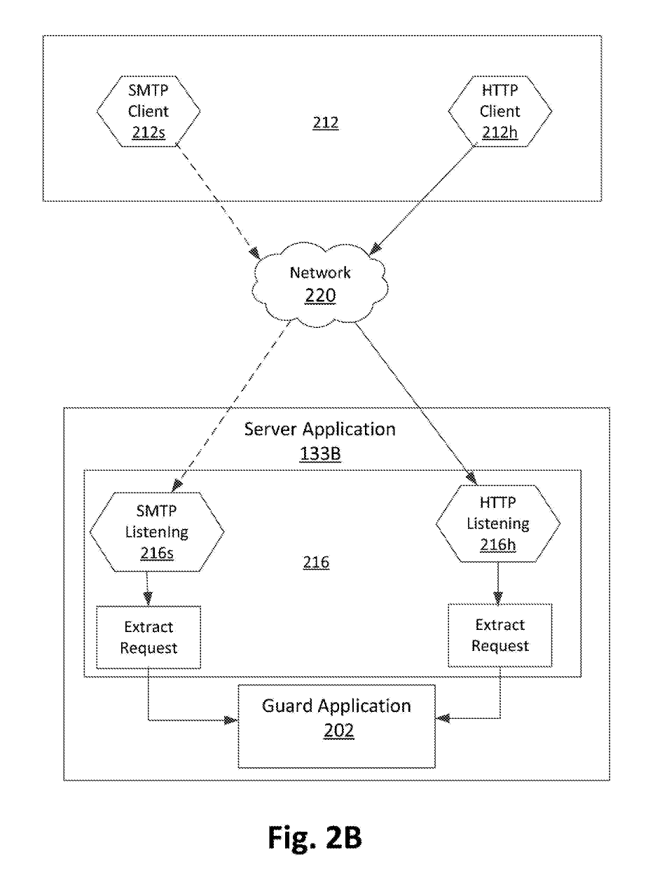

FIG. 2A shows an exemplary system 200 for manipulation of a document or software object. In the system 200, the server 177 includes a server application 133B, which executes upon a processor of the server 177 and an object database 204. The server application 133B comprises a guard application 202 and a listening application 216. The listening application 216 executes to receive a message call from the client device 101 and to extract information related to a detected user request from the message call. The guard application 202 is essentially a security application which implements access permissions to objects stored on an object database 204 of the server 177. The guard application 202 provides both access management and database management functions for the database 204.

Access permissions define how a user can access an object where the user is not the creator of the object. Access permissions may be applied to a full document (including all associated objects), or part of a document (for example, to only some of the objects), or to an executable object stored in a library of executable functions 206 on the database 204. Access permissions define a relationship between an object user and creator.

The database 204 stores objects created by users of the server 177, which may include or be associated with documents. Objects, whether data or executable objects, are preferably provided in JSON format and may include definition of relationships with other objects and have associated access permissions.

The library 206 contains predefined executable functions or tasks which may be used in manipulation of documents and/or objects. The tasks may be provided in industry standard (e.g., JavaScript) or custom programming libraries or headers as appropriate to any programming language in which the software 133 is provided. Each task normally has a task number for identification. Tasks are operations which return a single result or reply. Completion of one task may involve execution of a number of steps, but will provide a single result. For example, a ‘fetch object’ task may involve a single task step with the result being return of the fetched object. A compare task may involve execution of two preliminary “fetch object” tasks, and a third step of comparing the two fetched objects. The single result returned would be the comparison result.

The guard application 202 applies a single consistent security function to both data and objects of the database 204 and tasks of the executable library 206.

The application 133 comprises sections of object-oriented program code, preferably in languages C++, JavaScript and C#. The database 206 in which the objects are stored is preferably of open-source format such as a MySQL database with secure encryption.

In FIG. 2A, the server 177 is coupled to the client device 101 via a network 220, such as the networks 122 or 120 of FIGS. 1A and 1B. In the system 200, a graphical user interface (GUI) application 210 executes on the client device 101. The GUI application 210 may be any GUI-type application configured both to render document content and communicate over a network 220. A preferred type of GUI application is a standard web browser, however, other examples may include an email application, a word-processing application, and the like.

The GUI application 210 executes to render a presentation of the document on a display of the client device 101, such as the display 114 if the client device 101 is a computer, or the screen 178A or 179A if the client device 101 is the tablet 178 or the smartphone 179 respectively. The rendered document relates to a “View” of one or more objects associated with the document. In the following description, “a View” is a particular presentation of information and data rendered as a document by the GUI application 210.

The manipulation application 133A is executable on the electronic device 101. The manipulation application 133A executes persistently in association with the GUI application 210 and may be (i) downloaded each time the device 101 establishes communication with the server 177, or (ii) permanently stored on the memory 106 of the device 101. In case (i), the application 133A may be temporarily stored in dynamic memory of the device 101. In case (ii), the manipulation application 133A may be enabled whenever the GUI application 210 executes, or may require a trigger message delivered from the server 177 to confirm communication therewith has been established. The manipulation application 133A creates and manages a buffer 215 on the memory 106 of the client device 101. The buffer 215 is used to temporarily store functionality received from the server application 133B.

The manipulation application 133A may use a variety of protocols to communicate with the server application 133B. As shown in FIG. 2B, the detection process 212 typically includes an SMTP process 212s and/or a HTTP process 212h. The listening application 216 typically includes a corresponding SMTP system 216s and/or HTTP process 216h. Sub-applications for protocols such as HTTP and SMTP will differ only in relation to requirements of each protocol, both will operate in the same manner to produce the same result. However, SMTP processes will require reception of a reply email to manipulate a document or object. In contrast, a HTTP process will perform manipulation according to updates in the source data.

Returning to FIG. 2A, the manipulation application 133A comprises a detection process 212 and a manipulation process 214. The detection process 212 executes to provide functionality including detecting an interaction of the user with the GUI application 210. The manipulation process 214 executes to provide at least manipulation of an object represented by the GUI application 210, according to executable functionality received from the server application 133B, as described hereafter. The memory 106 may store a local version of a document viewed using the GUI application 210.

### Flowchart of Document Manipulation

### Client Side Operations

FIG. 3A shows an exemplary system 300 for creating and manipulating a document or object. In the process 300, the server application 133B essentially performs the same process of receiving a message, executing a task and providing a reply in each instance. The process executed by the server application 133B is indicated in process 350 and will be discussed in further detail in FIGS. 3B-3D. All other steps of the system 300 are executed on client device 101.

Returning to FIG. 3A, the process 300 starts at step 302 where the client device 101 accesses the server 177 via the network 220 to request or enable operation of the manipulation application 133A. The request to receive or enable the manipulation application 133A is typically provided by execution of the GUI application 210, for example upon initialisation of the application 210 or, in the case of a browser, upon direction to an address or URL of the server 177.

The server application 133B considers the access request 302 and performs step 350, returning a reply 304 to the client device 101. Where the requested access is allowed, the reply 304 provides or enables the manipulation application 133A. Disallowance of any request is discussed later with respect to steps 3508, 3704 and 3720. Upon receiving the reply, at step 306, the detection process 212 prepares and sends a message to fetch an initial Layout of a document from the server 177. The server application 133B again executes process 350 and, where allowed, returns a Layout 308 of FIG. 3A to the client device 101. At step 310, the user device 101 receives and renders the Layout 308 by execution of the manipulation process 214.

In the context of the present disclosure, a “Layout” is a particular View of a particular document or object associated with a particular user of the server 177, providing a personal View of a document or object. The Layout may include functionality such as a menu associated with the last use of the document or object by the user. The Layout is rendered on a display of the user device 101, such as the display 114. Document pages or content associated with the Layout will be required for rendering on the display 114. Therefore, in step 312, the manipulation application 133A prepares and sends a message to fetch pages of the initial Layout. The initial Layout includes a basic high-level menu of operations able to be selected by the user, including the ability to call for further menus. The manipulation process 214 receives a reply containing the content 313 of the initial Layout, and renders the content at step 314. Upon completion of step 314, a complete document Layout is presented to the user via the GUI 210.

The Layout provided will depend on the credentials of the user provided to the server 177. The credentials may, for example, comprise a user name and a password. Upon verifying the credentials, the server application can (i) provide the layout associated with that user and (ii) implement permissions associated with that user. If no credentials are provided, a default Layout such as a blank page may be rendered in step 314. The user will only have access to objects, including data and executable functions, available to any user until verified credentials are provided.

The detection process 212 detects interaction by the user with an object of a document at step 316. The detection process 212 executes in association with the GUI application 210 once the manipulation application 133A is downloaded and/or enabled on device 101. If the user interacts with object of the initial representation rendered by the GUI application 210, e.g., by use of a touch screen, or the mouse 103, such is detected at step 316. The detection process 212 incorporates in part a “two-operation” interface which monitors the GUI application 210 to detect user interaction. The two-operation interface monitors for two commands: (i) select+hold and (ii) select. Such operations are known to a standard computer user. The select+hold or select command may be implemented using the pointing or selection device associated with the device 101, such as a mouse, touchscreen, or pressure pad depending upon the type of client device, and associated hardware. Select+hold commands are implemented by, for example, holding down the click button on a mouse, and maintaining touch of the touchscreen for a predetermined amount of time. In some implementations, a ‘right-click’ of the mouse device 103 may replace the select+hold command, depending upon the nature and operating system of the user device 101. The two-operation interface further detects the object of the rendered document to which the user operation is directed, e.g., where the user clicks the mouse after selecting a menu option. Use of the select+hold command normally retrieves a menu, whereas a select command selects an item on a menu or an object presented by the display upon which a selected operation is to be performed.

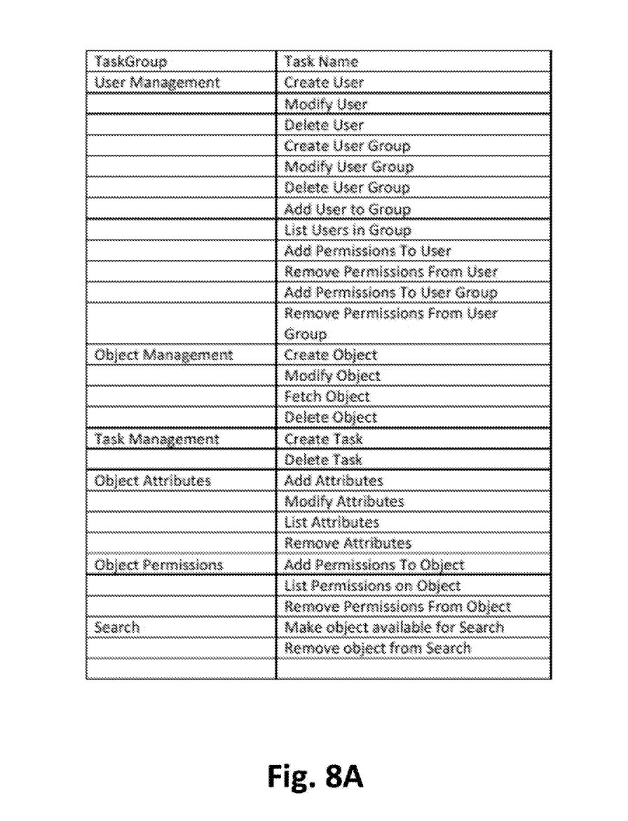

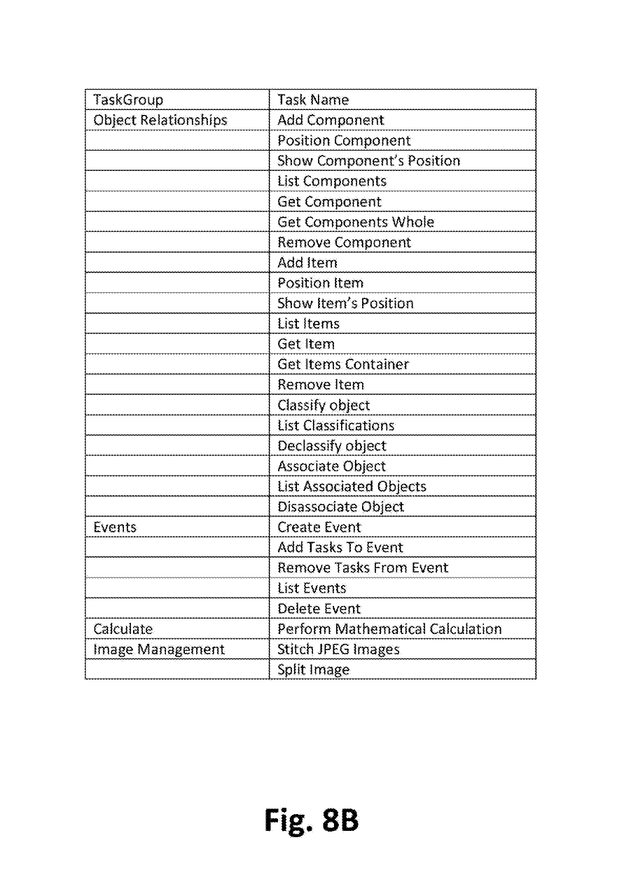

Upon detecting the user interaction, the detection process 212 executes to select at least one message from a plurality of predefined messages according to the interaction and associated object. FIGS. 8A and 8B show an exemplary collection of predefined messages from which the at least one message is selected. The messages of FIGS. 8A and 8B are sufficient to satisfy the requirements of most users to create or manipulate a document. The message call includes the at least one message in a data format suitable for object-oriented programming such as JSON.

Upon detection of user interaction, the detection process 212 checks at step 318 if functionality required to implement the detected interaction is available within the client device 101. For example, the required functionality may have been provided with the initial layout or may be stored in a temporary memory or buffer 215 of the client device 101, as described in relation to step 332. If the required functionality is available, the process 300 continues to step 324 without any communication with the server application 133B. Otherwise, the detection process 212 prepares a message (step 320) designating one of the plurality of executable tasks in the library 206 for the detected object. The message is transmitted to the server 177 as the message call. The server application 133B executes the process 350 and sends a reply 322. The process 300 then continues to step 324, wherein the detection process 212 checks whether the detected interaction requires execution of functionality for an object to be fetched, content to be saved, or permission to be assigned. In any of these events, the detection process 212 prepares a suitable message indicating the appropriate task or content at step 326 and communicates a message call accordingly to the server application 133B. The server application 133B executes process 350 to generate a reply, received at step 328 by the manipulation process 314. The reply may be in form of a message indicating whether the request was successful, or functionality executable on the client device 101 to manipulate representation of a document or object, or content to be presented by the GUI application 210. The process 350 proceeds to step 330.

The detection process 212 sends a message requesting functionality from the server 177 when the required functionality is not available locally (stored in the buffer 215) at the client device 101. If the required functionality is available at the device 101 at step 318 (and no server operation such as fetch/create etc. is required), the process 300 proceeds to step 324. The manipulation process 214 executes at step 330 to execute the received functionality and manipulate representation of the object or document rendered on the display 114. Step 330 results in rendering of an updated representation by the GUI 210. Manipulation may comprise adding, modifying or deleting presented content or presenting a menu. At step 332 the manipulation process 214 modifies a document object model (DOM) of the representation created by the GUI 210, and saves the updated DOM and functionality to local memory of the client device 101 as appropriate. The updated document is stored temporarily on the memory 106 of the client device 101. Executable functionality received from the server 177 is preferably stored in the temporary buffer 215 managed by the manipulation application 133A. The buffer 215 typically stores a limited, predetermined number of functions in a stacked manner on the memory 106. If the predetermined number of functions has been reached in the stacked buffer 215, the oldest stored (or least used) function is deleted when a new function is received. The buffer 215 is normally maintained until the session of GUI 210 is ended, when the buffer 215 is removed from, or may be overwritten in, memory 106 of the device 101.

Applications such as web browsers typically create a DOM, normally in form of mark-up language code such as XML. In this instance, the manipulation application 133A creates a DOM of content displayed in the GUI application 210. Changing documents using generic browsers normally involves editing the mark-up language of the DOM. The manipulation application 133A described herein uses JavaScript functions and data in JSON format to edit the DOM using functionality executed by the manipulation process 214. There are many techniques for DOM manipulation known in the art and which may be implemented in a number of ways according to different programming language requirements and styles.

### Server Side Operations

The process 350 executed by the server 133B is shown in greater detail in FIG. 3B and involves execution of the applications 202 and 216. The process 350 begins at step 3502, wherein the listening application 216 receives a message call from the client device 101, e.g., in step 320. The listening application 216 extracts the credentials of the user at step 3504. Further, the guard application 202 requests a connection to the database 204 based upon the extracted credentials. The credentials are validated by the guard application 202 at step 3506. Validating credentials typically involves matching a user name and a password provided by the user. If the credentials are found invalid, this result is returned to the client device 101 at step 3528. Communication of an “invalid” message is typically interpreted by the manipulation application 133A to render on the display of the client device 101 a message such as “credentials invalid, access denied”. Otherwise, if at step 3508, the credentials are found valid, the task required by the detected user interaction is extracted from the request by the listening application 216 at step 3510.

The required task is extracted by identification of a task number from a list of predetermined task numbers associated with the library 206. The task is identified at step 3512, and requested from the database at step 3514 to provide the required task. An access management process, described in further detail hereinafter, is then executed at step 370. Subsequently, at step 3516, the guard application 202 checks if the required task has been received. If the required task has not been received, for example because the required task does not exist or access permission to the task are not granted, the result is stored in a memory of the server 177 at step 3526, and the result returned to the client device 101 at step 3528. Otherwise, if the task has been received from the access management system 370, contents of the message are passed to the task for processing at step 3518. The task is executed at the server 177 by the server application 133B at the task execution step 390, to be described in further detail below. The result of the task, whether related to a data object, such as a newly created object, or a failure to perform the task for any reason, is stored on the memory of the server 177 at step 3520. The task is executed at the object database 204 if a database operation (as discussed hereafter in relation to step 3906 of FIG. 3D)

Once the task has returned a result, and the result has been stored on the server memory at step 3520, the guard application 202 checks at step 3522 if the received task has completed successfully. Checking whether the task completed successfully involves checking the result stored at step 3520 is a valid or invalid message or provides required functionality. If successful, the guard application 202 checks whether more messages were provided in the request at step 3524. If more messages were received, the process 350 returns to step 3510, otherwise the result of the task is stored in the memory of the server 177 at step 3526 and returned to the process 300 at step 3528. If the task did not complete successfully, that result is returned to the process 300 at step 3528. The result returned may comprise a message indicating whether the task was successful or not, or conveying content to be presented by the display 114. Content to be presented by the display may include object content, e.g., text or image content of components of the document. In some instances the result may include some functionality executable at the client device 101 which is required to manipulate representation of the document or object of the display 114, corresponding to the interaction detected at step 316, i.e., at least one of content and functionality may be returned.

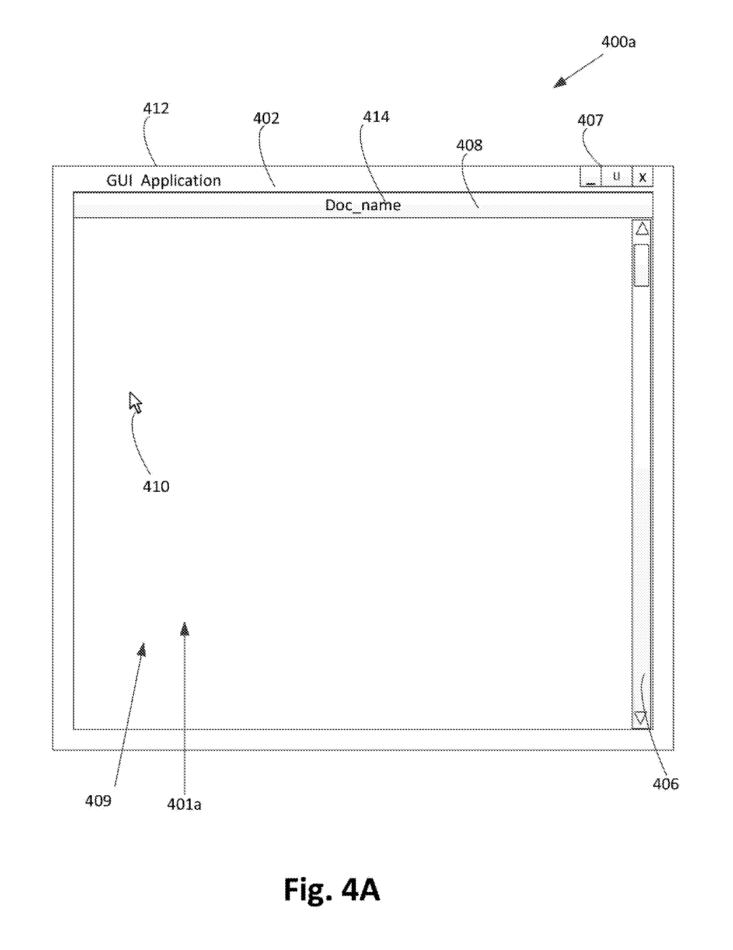

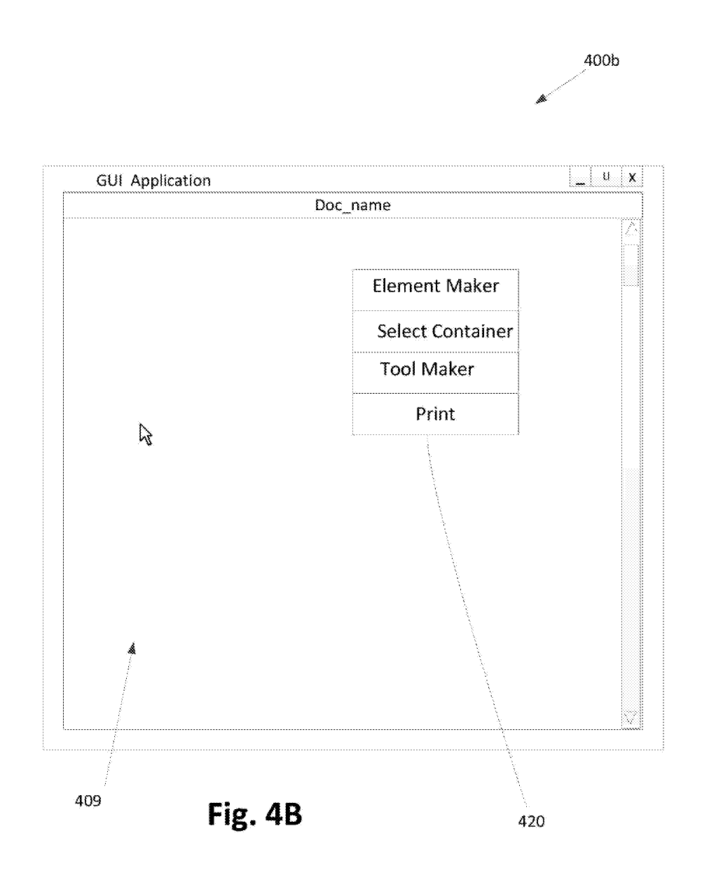

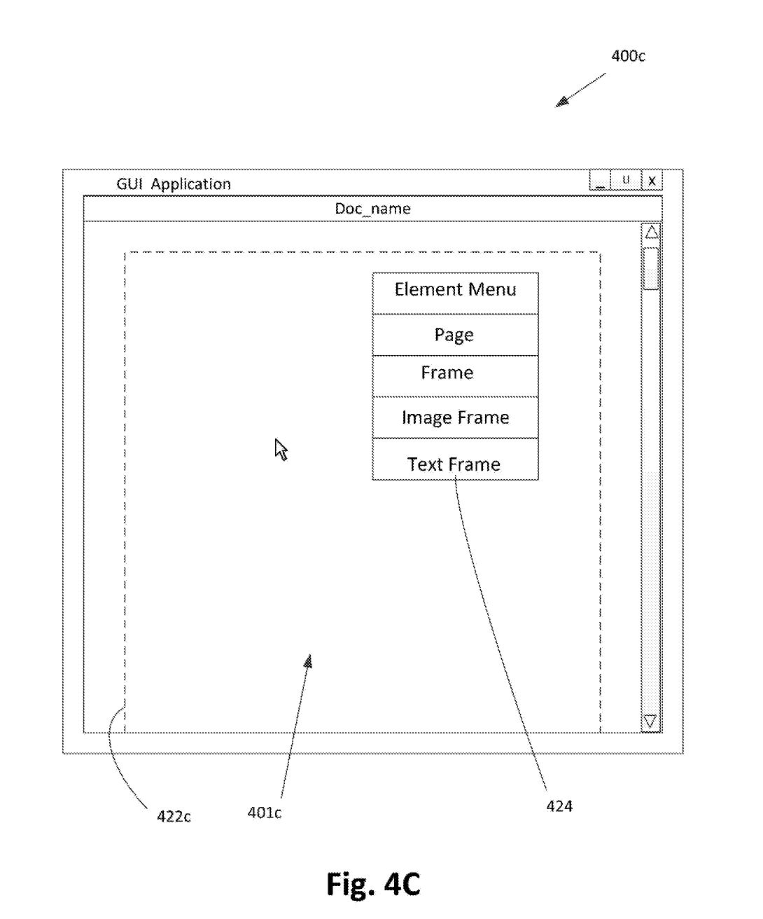

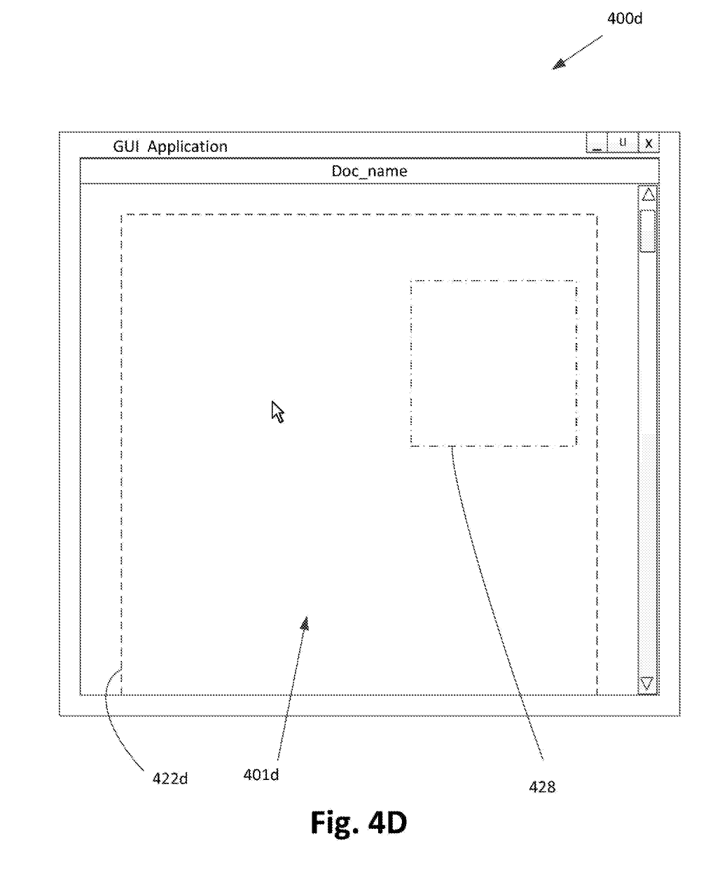

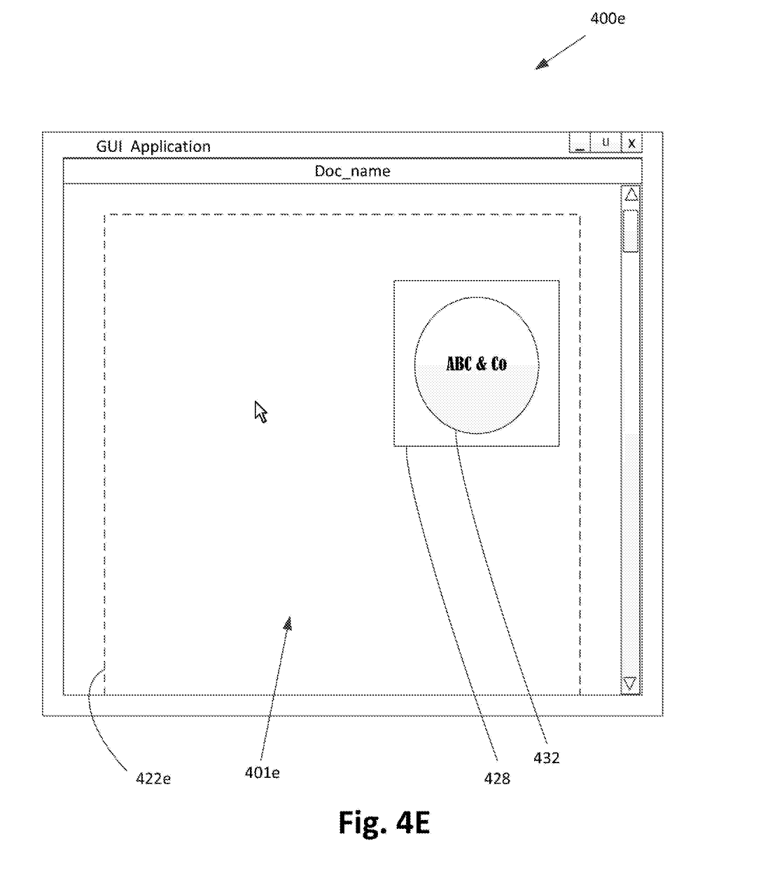

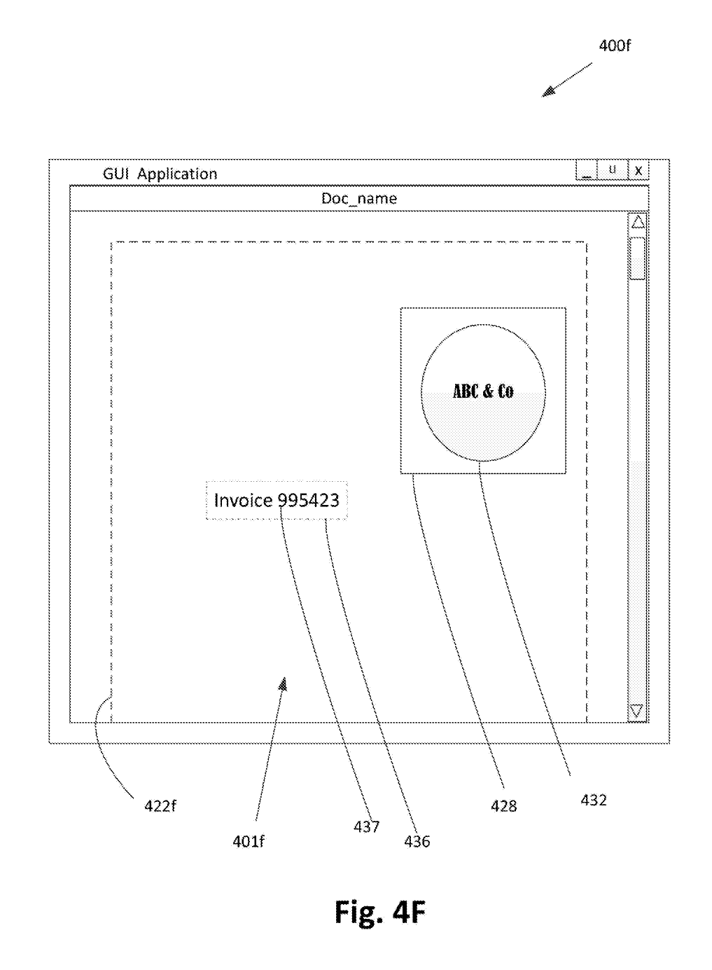

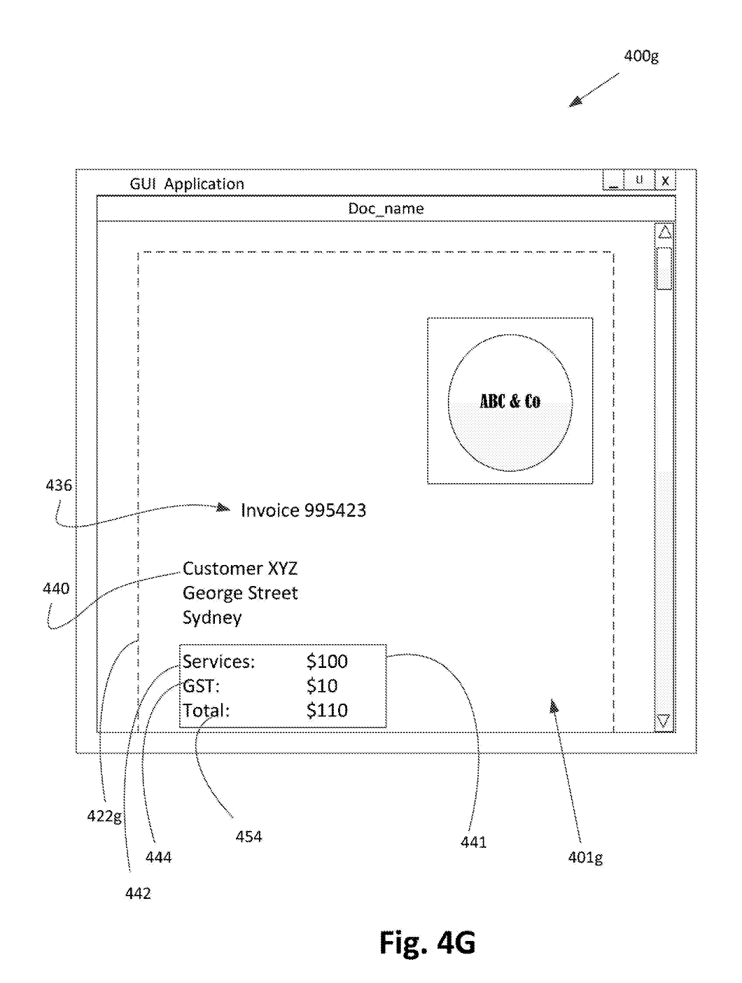

FIG. 3C shows an exemplary breakdown of the access management process 370 of FIG. 3B. The process 370 begins at step 3702 upon receiving a request for a task or a database operation. The process 370 is executed on a processor of the server 177 in relation to the object database 204. The process 370 executes to check whether the request operation is allowed at step 3704, e.g., does the access permission between the object user and creator allow such a function. If the step is not allowed, e.g., if the user does not have permission to use the identified task, the result is stored on the memory of the server 177 at step 3726, and the result is returned to the process 350 at step 3728. Alternatively, if the request for operation is allowed, the process 370 checks if the requested task is to create an object at step 3706. If the request is to create an object, for example, to create an image object as in FIG. 4D, the object is created at step 3708 on the database 204. The created object may be a document, or one of the object components of a document. When created, the object will have an identification number and an access permission associated only with the creator, but no other attributes unless defined by the user interaction. For example, the object may have an identification number of ‘456789’. Once created, the result is stored on the database 204 at step 3726, and a positive result returned to the process 350. A negative result would include indication that the task was unable to execute, e.g., due to user permissions or the like. A user is by default afforded full access permissions to any object they create. However, no other user of the server 177 is afforded any access permission to the creator's objects unless the creator defines such an access permission relationship for that user.

Alternatively, if the identified task is not to create an object, as determined in 3706, the process 370 requests an object, as indicated in the user request, at step 3710. The object, e.g., a text object, is fetched at step 3712 from the database 204. An example of when an object is fetched is upon loading an initial Layout when the user provides a credential identifying their session and permissions to the server application 133B. In this instance, an object provider will be that defined by the Layout. The database manager provides a response, the response being received and checked to determine if the requested objects have been received at step 3714. If the object has not been received, the result is stored on the memory of the server 177 and returned at steps 3726 and 3728 respectively. In such instance, e.g., if the object number did not exist, the result may result in a message being returned to the user such as “object unavailable” or “access denied to object”.

If the object has been received, the process 370 progresses from step 3714 to step 3716 to request permissions related to that object. The permissions are fetched from the database 204 at step 3718. Fetching permissions is executed in a similar manner to fetching the object at 3712. If permission to perform the requested operation is found at step 3720, the process 370 progresses to step 3722. At step 3722, the process 370 checks if the requested operation is to “fetch” an object. If a “fetch”, the process 370 progresses to step 3726. If a “fetch” is not required at step 3722, the process 370 attempts to perform the requested operation at step 3724. The corresponding result is stored on the memory of the server 177 at step 3726 and returned to convey content, or indicate to the user whether the requested operation was successful, or to provide required functionality for execution at the user computer 101.

If permissions to perform the requested operation are found not to be provided at step 3720 of the process 370, the result stored on the memory of the server 177 and returned result would indicate to the client device 101 that the user is not allowed to perform the requested operation.

The access management process 370 thus ensures that a user must have access permissions to both a data object and a executable object in order to complete a task resulting in document or object manipulation. Application of the same security mechanism, and storage on a similar database, of both data and task objects provides a consistent security solution.

The process 390 for task execution of FIG. 3B is shown in detail in FIG. 3D. The process 390 is performed by the server application 133B and starts at step 3902 to accept a message upon receiving a request to process a task. The request is processed to identify a work-piece involved in step 3904. A work-piece is used in this context as a general operation executable on the server 177, examples including fetching or creating an object, executing a task from the library of functions 206, or a sequence of functions in the library 206 and associated objects, and the like. Tasks are preferably constructed to be as simple as possible such that tasks can easily be combined to create a sequence of work-pieces to implement specific user requirements. For example, a task with three work-pieces may involve (i) fetching an object, (ii) fetching another object, and (iii) comparing the two fetched objects. An example of a task with two work-pieces is fetching the next page of a document, which involves (i) determining which page is the current page, and (ii) fetching the subsequent page. Once the work piece is identified, the system 390 attempts to execute the required task. Firstly, the process 390 determines whether required operation is a database operation or not at step 3906. Examples of a database operation include saving or fetching an object, or applying permissions to an object of the database 204. A non-database operation could include an operation such as performing a calculation on some values provided by the user, or comparing attributes of objects fetched from the database 204.

If the work is not a database operation, the process 390 proceeds to step 3908, and attempts to complete the requested operation. Step 3910 then operates to check if the attempted operation was completed successfully in step 3908. If at step 3910, the process 390 finds the operation completed successfully, the result is stored in the memory of the server 177, such as the memory 106. The process 390 checks at step 3914 if all work to implement the required task is complete, e.g., have both objects been retrieved and compared. If the task is found not to be complete, the process 370 returns to step 3904. Otherwise, the process 390 continues to step 3918 and ultimately returns the result at step 3920.

Where a database operation is required at step 3906, the process 390 proceeds to step 3916, wherein a database operation is requested. In order to request the database operation, the access management system 370 (as described in FIG. 3C) is required to operate to ensure permissions are allowed in this regard. If the access management system 370 provides a successful result, the requested database operation is performed (as at step 3708 or 3724) and the process 390 proceeds to step 3910.

Where step 3910 determines that the task has been unsuccessful, this result is stored on the memory of the server 177 at step 3918, and the result returned again at step 3920. Tasks always reply with a result relating to either “Success” or “Failure”, according to whether the task was completed or not. If the result is Success, the reply will include information or functionality requested. If the result is Failure, the reason for the failure is supplied.

### Manipulation of a Blank Document—Document Creation

FIG. 4A shows a view of a window 400a rendered by execution of the GUI application 210 on the client device 101, e.g., via the display 114. The window 400a comprises a frame 402, which includes a name 412 of the application. A document name 414 is displayed within the document name or address bar 408 if a named document is open. A plurality of control buttons 407 are provided to control representation of the window 400a within the display 114. A scroll bar 406 is provided to navigate data represented within the window 400a. A cursor 410 is represented within the window 400a, by which the user can interact with the window 400a, such as using the mouse device 103. The representation of the document rendered in the window 400a within an area 409 enclosed by the frame 412.

The window 400a is rendered following the client device 101 establishing communication with the server 177 (steps 306-314 of FIG. 3A), and download and/or enablement of the manipulation application 133A on the client device 101 (steps 302-304 of FIG. 3A). Unlike many standard document manipulation applications, no menu bars, tabs or options (referred to as “chrome” in relation to some browsers), are provided in the window 400a.

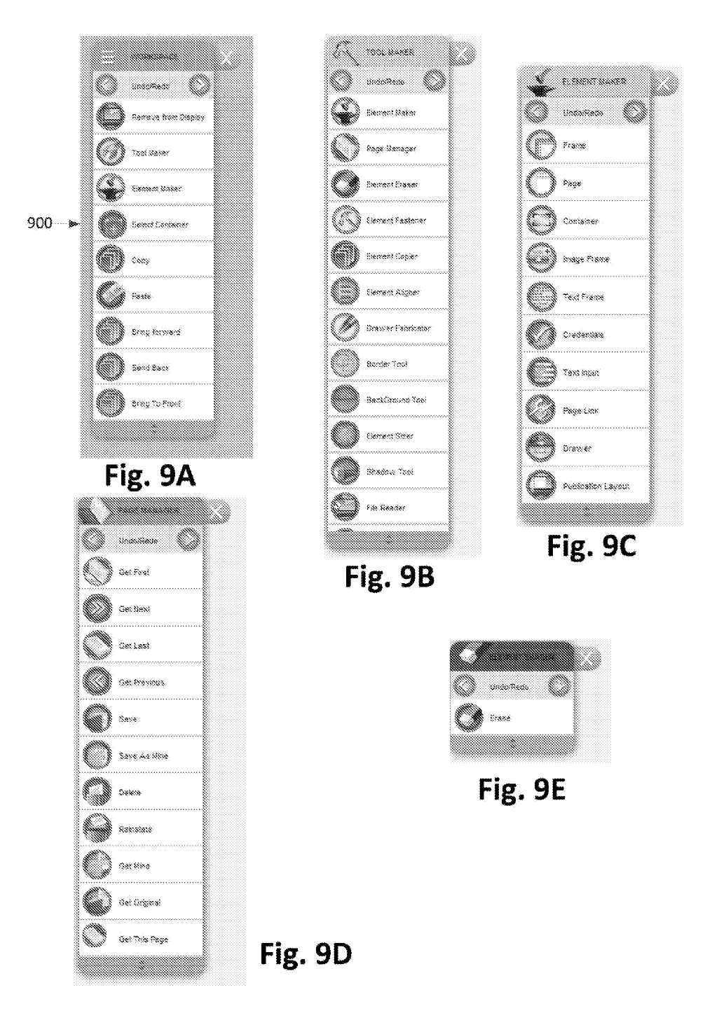

Documents, and components of documents, are represented by software objects in the description provided herein. In FIG. 4A, no document is displayed. This could be considered a blank document being displayed by the GUI application 210. A blank or initial display may be set to a default document object by the server application 133B. The user can, subject to access permissions, access a basic menu for document or object manipulation by interaction with the area 409 and execution of the 2-operation interface of the detection process 212. In some implementations, a basic menu (for example, shown in FIG. 9A and discussed later) may be included in an initial Layout associated with the blank document of a View 401a presented in the area 409.

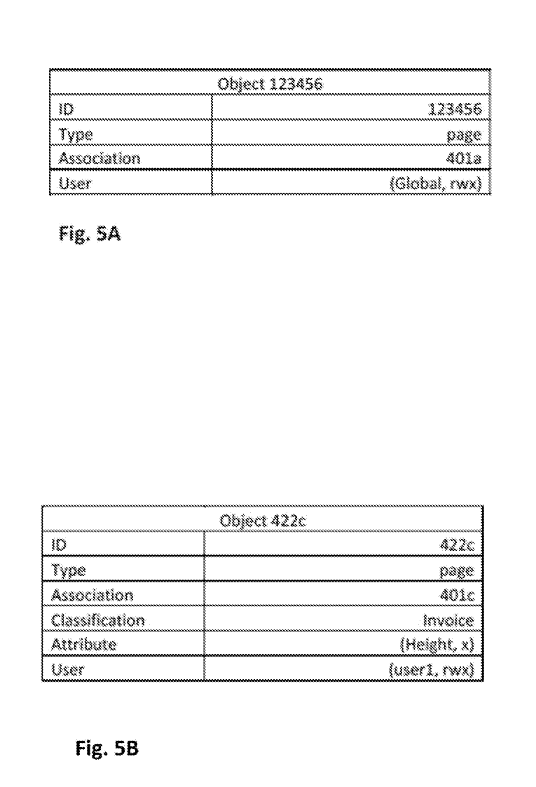

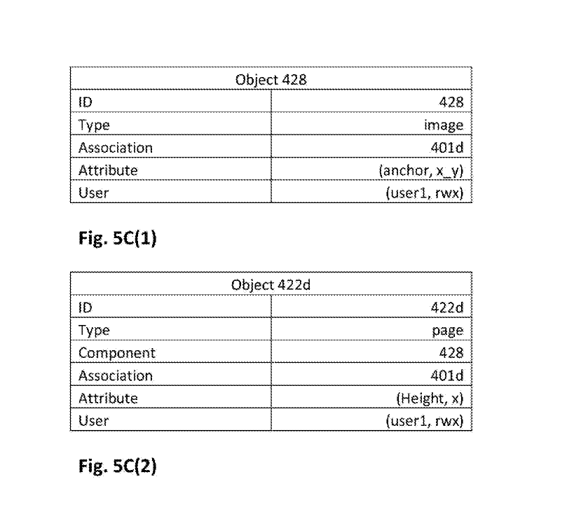

FIG. 5A represents the default document object in tabular form. Objects described below are normally encoded in JSON format. However, for ease of reading and comparison, objects in FIGS. 5A-5C are shown in tabular form. Every object has an identity (ID) field. Some objects may also have a plurality of collection fields including a type, component, items, an association, a classification, users and, optionally, attributes.

Collection fields such as types and attributes are user-defined. The user designates the type considered most appropriate, e.g., a page or an invoice. Attributes are name/value pairs where the name describes the attribute (e.g., Size, Weight,) and the value contains the associated value (e.g., 10, 100). Collections of users, user groups, and associated access permissions may also be defined by the user and stored on the database 204 using a collection field of an object. Some attributes may be added according to a menu selection, e.g. Create Object v Create Image. More than one access permission may be provided depending on the number of associated users.

Relationships between objects have four types: Components, Associations, Items, and Classifications. All relationships that exist between two objects associated with a document can be represented in the system 200 by these four types. Components are objects that make up other objects. Items are “contents” of an object. Associations define objects that have a loose (“independent”) connection with other objects. For example, Views are Associated with documents. In some instances a document is referred to as a “Publication”. Classifications enable objects to be classified as other objects, e.g., a page may also be an invoice.

In the example of FIG. 5A example, the blank display might be a default display having ID “123456”, and type “page”. The user attribute of (global, rwx) may indicate that global users, i.e., every user has read, write and execution access to object “123456”. Object 123456 of FIG. 5A is associated with a View 401 a rendered in the window 400a.

On receiving data associated with View 401a to render in area 409, the GUI application 210 will firstly receive object data regarding the View or Layout 401a, and subsequently object data contained within the View. Such corresponds to steps 306-314 of FIG. 3A. Unlike typical document manipulation applications, the GUI application 210 does not present a fixed set of menus in the menu bar. Rather, user interaction and instructions are interpreted by the detection process 212 via the 2-operation interface. Tools presented are thus relevant to the detected user interaction and menu functionality executed by operation of the manipulation process 214.

Upon detection (step 316 of FIG. 3A) of a user interaction with content of the representation formed by the window 400a, the detection process 212 checks if the required executable function is already available on the user device 101 (step 318 of FIG. 3A). For example, the detection process 212 checks if the buffer 215 of tasks has been created in the temporary memory of device 101, managed by the application 133A. In this instance, the required executable function (a basic menu) is not available. The detection process 212 selects at least one message from a plurality of pre-defined messages, depending on the detected operation. In this instance, when the detection application 212 detects a select+hold command in the area 409, the detection application 212 selects at least one message relating to presentation of a basic menu. The selected at least one message is communicated to the server application 177 as a message call, per step 320.

The server application 133B receives the message call, retrieves corresponding executable function from the library 206, and executes step 350 of FIG. 3A. A reply regarding the attempted execution is transmitted to the device 101, such as a “success” or “failure” message or required functionality, as per reply 322 of FIG. 3B. Upon receiving the reply 322, the detection process 212 checks if the reply received from the server application 133B for the detected interaction relates to functionality for fetching or saving an object, or applying access permissions (step 324 of FIG. 3A). In this example, such is not required.

Each of the tasks of the library 206 is associated with at least one of the predefined messages of the detection process 212, for example the messages of FIGS. 8A and 8B, and is selected according to the message call. In this instance, the task requires execution at the client device 101, and the selected task is communicated to the client device 101, as per step 322 of FIG. 3A. As the task relates to execution of a menu function rather than to fetching, sending or saving content, or applying access permissions (step 324), the manipulation process 214 executes the selected executable function to render a menu 420 on a display of the client device 101, resulting in rendering of the manipulated presentation 400b of FIG. 4B. Such relates to step 330 of FIG. 3A. As the menu does not form part of a document, rather is transient in nature, objects associated with the document rendered in the area 409B are unaffected. However, if the user saved a Layout at this juncture, the menu 420 would be included in the Layout. The executable functionality received with the reply 322 from the server 177 is temporarily stored in a local memory of the user device 101. The functionality is stored in the buffer 215 managed by the manipulation application 133A.

In FIG. 4C, the user has selected the option “Element Manager” of the menu 420 using a select command and the cursor 410. The detection process 212 detects such interaction and checks if the required executable function is available at the client device 101. In this instance, the Element Manager functionality is not available. The detection process 212 communicates a corresponding message call to the server 177 in a similar manner to that described above. As the “Element Manager” tool has not been previously provided, or therefore temporarily stored on the buffer 215, an appropriate message call is sent to the server 177 in the manner described above. The server application 133B executes process 350 accordingly and, if permitted, the requested functionality is transmitted in a message to the client device 101. The manipulation process 214 executes the functionality to render a further menu 424 in representation of 400c of the GUI application 200 and the client device 101, as shown in FIG. 4C. The user selects the “page” option from the menu 424 and clicks on the display area 409 of the window 400c. The detection process 212 detects this interaction, checks if the required executable functionality is available, selects a corresponding message to create a page, and communicates a message call accordingly to the server 177. The server application 133B executes step 350 and communicates appropriate functionality to the client device 101. The manipulation process 214 executes the received functionality to render an outline of a page 422c in the display area 409.

If, at this stage, the user saves the page 422c created, steps 318 through 328 of FIG. 3A will execute (if access permissions so allow) and an object 422c will be created at the database 204 of the server application 177, as per step 3708 of FIG. 3C. A representation of the object 422c is provided in tabular form in FIG. 5B. Additionally, using the interface, the user may add a classification for the object, such as “invoice”, and provide an attribute, such as a height for A4 paper. In this instance the user is user1. User1, as the creator of the object 422c, is the only user to have access to object 422c by the guard application 202. Guard application 202 affords user1 full “rwx” (read, write, execute) access thereto.

The predefined messages from which the detection process 212 selects to prepare a message call are accessed hierarchically through the menus provided by the server application 133B. Presentation of the menus means that a user is not required to locate correct functionality tabs or buttons in the manner of a traditional document of manipulation application. For example, in Microsoft Word™ or Google Docs™, tool bars are displayed with fixed functionality.

In the presently described arrangements, tools are provided by temporarily displaying a hierarchical menu structure and execution of a selected menu option for a selected object (i.e., the object or content selected subsequently to the menu option). A user therefore does not have to find the correct tab or button of the application 210. Instead the user can simply navigate through the menus as selected. The predefined group of messages thus provides powerful functionality in relation to manipulation of a document. Example menu options are provided in FIGS. 9A-9E. Menu 900 of FIG. 9A shows a sample ‘basic menu’ or ‘multi-function tool’. The multi-function tool 900 preferably provides some basic manipulation functionality for which interaction with the server 177 is not required, and means to access tools which require functionality to be provided from the server 177.

A number of options shown by the multi-function tool 900 such as “Copy”, “Paste” and “Bring forward” operate in a manner similarly to such functions in a traditional document manipulation application, and do not require execution of the process 350 of the server application 133B. Other options of the multi-function tool 900 relate to the user being presented with a further menu, e.g., the menu of FIG. 9B upon selection. Execution of the process 350 will be requested for the user to access such a menu unless associated functionality is already stored in the buffer 215.

The menu of FIG. 9B relates to tools for object manipulation. For example, the option “Element Aligner” may be used to align presentation of one object relative to another object of the document without execution of the process 350 on the server application 177. (If the resultant document were saved, the process 350 would be required to save that presentation.) Other options of the menu of FIG. 9B, e.g., “Element Maker”, “Page Manager” and “Element Eraser” provide further menus, the menus of FIG. 9C, FIG. 9D and FIG. 9E respectively,

The menu of FIG. 9C provides functionality associated with creating an object, e.g., “Text Frame” is used by the user to create a frame for a text object. The menu of FIG. 9D relates to functionality for managing a page, e.g., “save” is used to store a page object on the database 204 with access permissions for people other than the creator, and “Save as Mine” stores a page on the database 204 with access permissions provided to the creator only. The menu of FIG. 9E relates to removing an object, e.g., a text or image object from a page.

In this manner, updates to the functionality may be provided by addition of messages and to the application 133A and of corresponding tasks of the library 206. The menus may thus be altered or extended at the server 177, without the user or the client device 101 installing any updates, or changing known layout of the menus.

Returning to FIG. 4C, the user now wishes to add an image to page 422C. The user manipulates within the GUI 210 presented by the client device 101 (FIG. 2A) to navigate through menus provided by the server application 133B in a similar fashion to that described in relation to FIGS. 4A-4C defining a “create image” option. In response, the server application 133B executes the process 350 to create an image object, as per step 3708 of FIG. 3C. The reply received by the client device 101 upon execution of the process 350 is interpreted by the manipulation process 214 to render an empty image object 428 shown in FIG. 4D in the manner described hereinbefore. A window 400d in which the empty image object 428 is rendered in a View 401d. FIGS. 5C(1) and 5C(2) represent objects associated with the view 401d, should page 422d be saved at this stage. Object 428 of FIG. 5C(1) has a type “image” and is associated with the view 401d. Additionally, the object corresponding to the page 422d (FIG. 5C(2)) now includes objects 428 of FIG. 5C(1) as a component. The updated display is saved in the buffer 215 in transient memory of the device 101 per step 332 of FIG. 3A. Functionality received from the server application 133B is stored in the buffer 215 in the transient memory of the device 101.

The user next adds an image for display by the image object 428. In some instances the image object 428 will display a select button for opening a directory of the client device 101, such that the user can select the required image from the memory 106 (FIG. 2A). In this instance, the user can retrieve a client device direction 101 to obtain the desired image, by display of a menu, and by navigating a menu provided by the server application 133B, in a similar fashion to FIGS. 4A-4C.

FIG. 4E shows a GUI application window 400e, in which an image 432 has been added to the image area 428. To achieve this, the server application 133B creates (i) a copy of the selected image (logo.jpeg) in the database, and (ii) an object associated with that image for inclusion in the image object 428. Alternatively, the image 432 could be added to the presentation 400e of FIG. 4E directly as an object. In this event, a single object for the image would be created at the database 204 if the document 422e was saved.

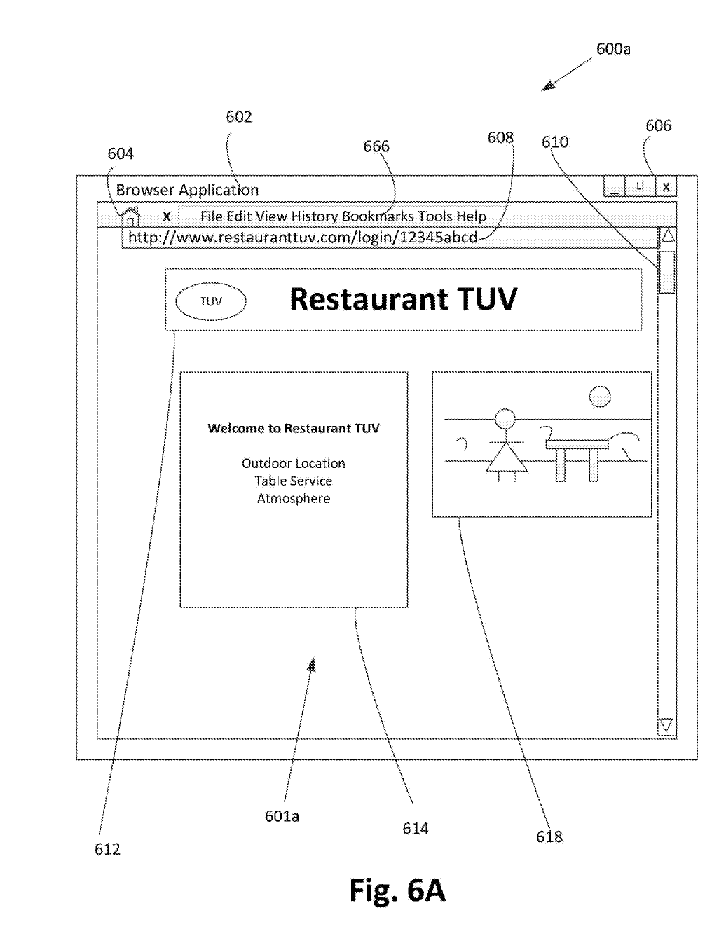

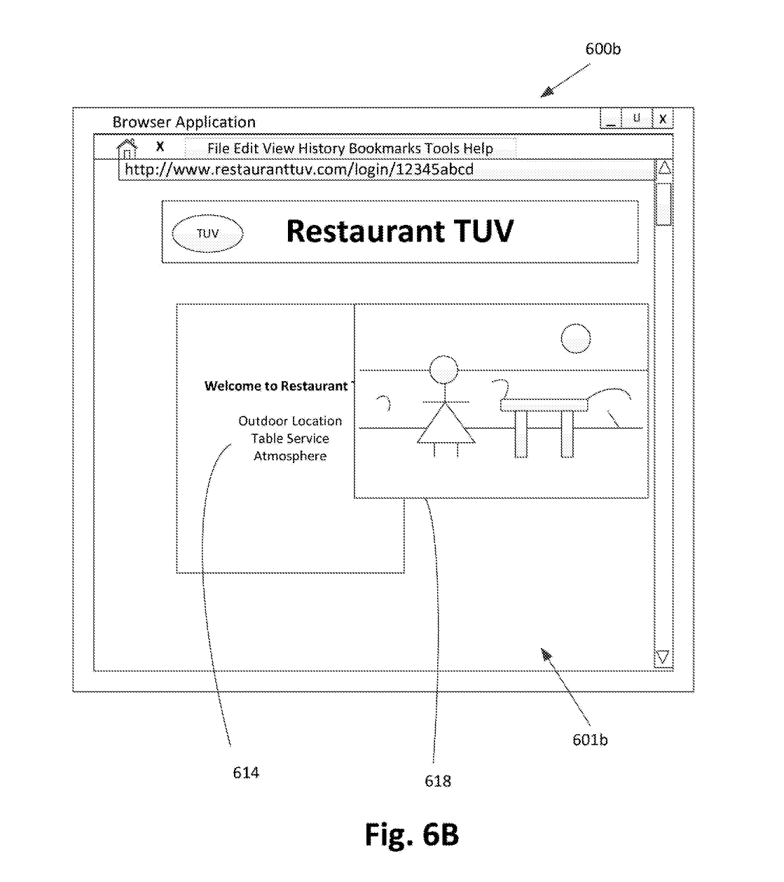

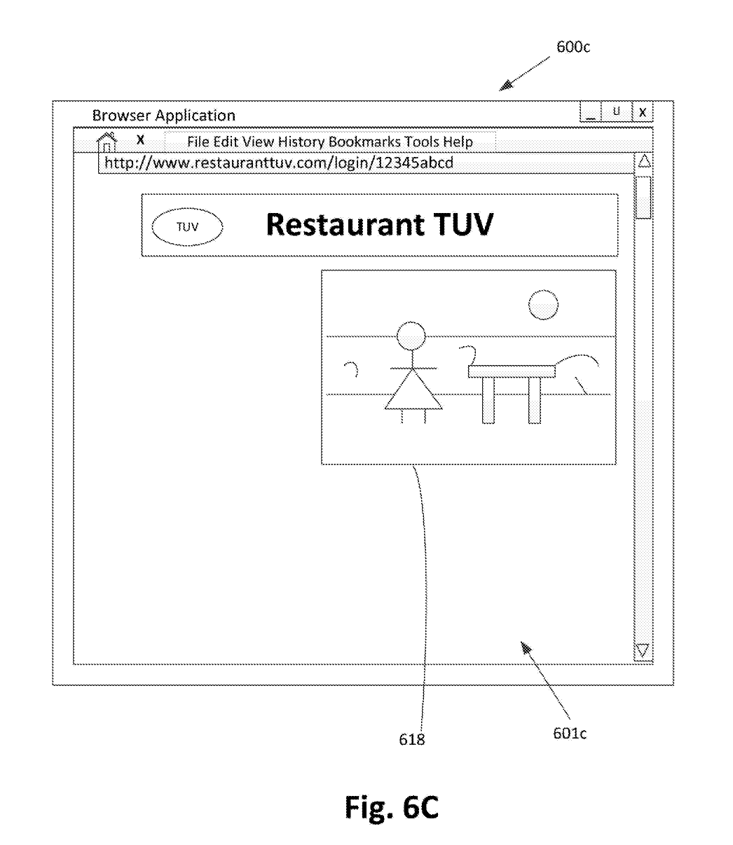

The user then proceeds to add a text object 436 to the page 422e to create an updated page 422f, as shown in window 400f of FIG. 4F. Functionality associated with creating and displaying a text object is retrieved from the server application 133B (in a similar manner to retrieval of functionality for creating the image 428 of FIG. 4D) and saved in the buffer 215, as per step 332 of FIG. 3A. An object 436 of type “text” is created at the object database if the user saves the updated View 401f (FIG. 4F). A corresponding text object 437 is then created according to user interaction, and is an associate of object 436 of FIG. 4F. When the detection process 212 (FIG. 2A) detects at step 316 of FIG. 3A that the new text object 437 of FIG. 4F is required, the buffer 215 is checked for available functionality (step 318 of FIG. 3A). As this functionality is stored in the buffer 215 from creation of the object 436 (FIG. 4F), the process 300 of FIG. 3A proceeds from step 318 (FIG. 3A) to step 324 (FIG. 3A) to check that the user has permission in this regard. The corresponding text object 437 (FIG. 4F) is created and provided with attributes associated with the object 436 (FIG. 4F) upon instruction by the user. The data stored in object 437 may include text content of the object 436 (FIG. 4F) and attributes such as font type. The text object 437 relates to text content of the text object 436 of FIG. 6F in a similar manner to how the image 432 (FIG. 4E) relates to the image area 428 of FIG. 4E.

The user proceeds in the same fashion to add a number of additional items such as text object 440 (FIG. 4G) indicating a customer name and address, and a text object for billing data 441 (FIG. 4G), to create an updated page 422g. Rendering of the page 422g is shown in window 400g of FIG. 4G. The text content of item 440 (FIG. 4G) may be derived from an object stored on the server 177 in a similar manner to the image object above. Alternatively, a task may be defined to dynamically enter text upon being directed by the user to appropriate attributes of other associated objects of the database 206 of FIG. 2A.

User1 adds access permissions for user2, e.g., the recipient of the document 422g (FIG. 4G) by navigating menus via the 2-operation interface as described above. The guard application 202 executes a database operation accordingly as at step 370 of FIG. 3D to apply a “read only” permission “r-” to the document 422g (FIG. 4G) according to user interaction such that user2 can only read the document and object content of 422g (FIG. 4G).

### Manipulating a Previously Created Document

The applications 133A and 133B can also be used for manipulating a document previously created, whether the user is the creator or not, if access permissions provide such a relationship between the user and the creator.

FIG. 6A shows an example in which the GUI application 210 is a generic browser application such as Internet Explorer™ (Microsoft Corp.), Firefox™ (Mozilla Corp.), Safari™ (Apple Corp.), Opera Mini™ (Opera Software ASA), and the like. A browser window 600a (FIG. 6A) is rendered by execution of the GUI application 210 of FIG. 2A, in this instance a browser, on client device 101. The window 600a of the GUI 210 shown in FIG. 6A has the normal features of a browser window, including a browser name 602, URL 608, control buttons 606 and scrollbar 610. The browser window 600a (FIG. 6A) has typical browser menu buttons 666 such as “File”, “Edit”, “View”, “History”, “Bookmarks”, “Tools” and “Help”. The browser window 600a of FIG. 6A renders a view 601a associated with a document, hereafter “document 601a”. The document 601 a was created by a user, user1, and, as shown in FIG. 6A, has three object items—a text/logo object 612, a text object 614 and an image object 618. Menus such as those provided by the buttons 666 of FIG. 6A, or menus typical to a cloud-based document editing application are not used to manipulate the document 601a in this instance. The browser 210 of FIG. 2A is used only as a GUI display area and as a means of communicating with the server 177. For example, a ‘print’ command accessed via the “File” option of the buttons 666 (FIG. 6A) would not be used to print the content associated with the document 601a (FIG. 6A), as such would only print content as interpreted by the GUI Application 210. Instead, to print the document 601 a (FIG. 6A) according to the present disclosure, the user would use a ‘print’ option of menus interactively retrieved from and provided by the server application 133B (e.g., the menu 420 of FIG. 4B). The different pages of a document would each be converted from JSON format to Adobe pdf format by the server application 133B such that pages are separated for printing. The selection of menu items and functionality is user-driven via interaction with content rendered on the display 114 of FIG. 1B. These are provided from the server 177 according to user interaction detected at step 316 of FIG. 3A.

In this example, the document object associated with document 601a of FIG. 6A is being accessed by a user, user2, having a relationship with creator user1 that defines full “rwx” access to the document 601a.

However, returning to FIG. 6A, user2 has full permissions and wants to change the document 601a. User2 navigates menus provided by the server application 133B by use of the 2-operation interface. The user finds an “image resize” tool. The detection operation 212 (FIG. 2A) detects the interaction in a similar manner to that discussed in relation to step 316 of FIG. 3A, checks if the required functionality is available, and sends a message call to the server 177 if not. The server application 133B provides menus and/or functionality via process 350 of FIG. 3B. User2 selects and resizes the image object 618 (FIG. 6A) using a cursor (not shown) to create the new view 601b as shown in FIG. 6B.

User2 decides that the object 614 of FIG. 6B is unnecessary and deletes object 614 from the view 601b of FIG. 6B. Such results in view 601c, as shown in FIG. 4C. Deletion of the object 614 (FIG. 6B) from the View 601 b (FIG. 6B) is an example of manipulation which may be implemented via execution of components of the multi-function tool 900 of FIG. 9A. This manipulation is performed by the user selecting the ‘Remove from Display’ function of the tool 900 and subsequently clicking on the representation of object 614 of FIG. 6B. Such operation does not require operation of the process 350 of FIG. 3A as the required functionality is already available on the user device 101 to the manipulation process 214, and no database operation is required. Other examples of such operation include moving or copying an object, and the like. However, if the resultant manipulated page is saved, execution of the process 350 of FIG. 3B is required.

User2 can save the content of the view 601c, hereafter referred to as document 601c (FIG. 6C), on the object database 206 (FIG. 2A) of the server 177 as user2 has full “rwx” access permissions to the document 601a (FIG. 6A). User2 selecting ‘save’ on a menu provided to the user device 101 by the server application 133B results in execution of step 326 of FIG. 3A. The process 350 of FIG. 3B executes accordingly. As user2 has full access permissions to the document 601a (FIG. 6A), access management process 370 of FIG. 3C finds that the requested ‘save’ operation is allowed at step 3704. The document 601c is saved by a corresponding object being created at the database 204 (FIG. 2A) at step 3708 of FIG. 3C. Once the document 601c is saved on the database 204 (FIG. 2A), user2 can retrieve the document 601c (FIG. 6C) in a later session of the browser application 210. The document 601c can form a Layout associated with user2 and distinct from the Layout originally accessed by user2. Other users of the server 177, including user1, cannot access the document 601c unless user2 provides those users with appropriate access permissions.

If another user, user3, having only a read relationship with user1 (e.g., a general public access) were to access the document 601a of FIG. 6A, user3 would have permission to view the document 601 a. Any user that has read access permissions can modify any of the content as presented by the GUI application 210—access permissions are not checked until that user attempts to save any content to the server 177. User3 can therefore manipulate presentation of the document 601a (FIG. 6A) by the GUI application 210 by accessing menus provided by the server application 133B. This can correspond to, for example, the changes performed by user2. User3 however does not have access permission to save any content associated with the document 601a or save a personal Layout of the document 601a. Accordingly, any attempt by user3 to save a change in the presentation or content of the document 601a (FIG. 6A) would result in execution of step 326 of the process 300 of FIG. 3A. The server application 133B would execute process 350 of FIG. 3B, denying saving of the document, resulting in the server application 133B rendering an error message as at step 3704 of FIG. 3C to be displayed to user3 via the GUI 210.

The division of tasks performed by each of the applications 133A and 133B may be varied according to different implementations of the application 133, e.g. creation of the initial user document may be implemented by the Manipulation application 133A on the computer 101. The applications 133A and 133B may in some implementations be provided separately for use with other, separate applications. The sequences of processes 300, 350, 370 and 390 of FIGS. 3A-3D may vary in other implementations, for example, the sequence of steps 318-330 of FIG. 3A.

### Hierarchy of Objects

Objects Such As A Document are represented hierarchically in the DOM of application 210. The relationships of these objects can also be considered to provide a hierarchy.

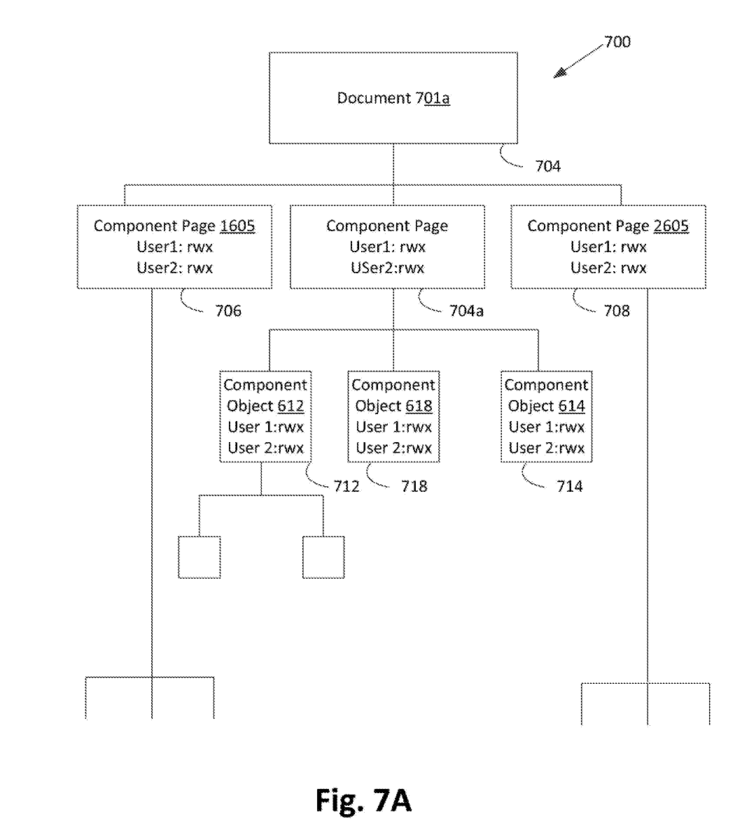

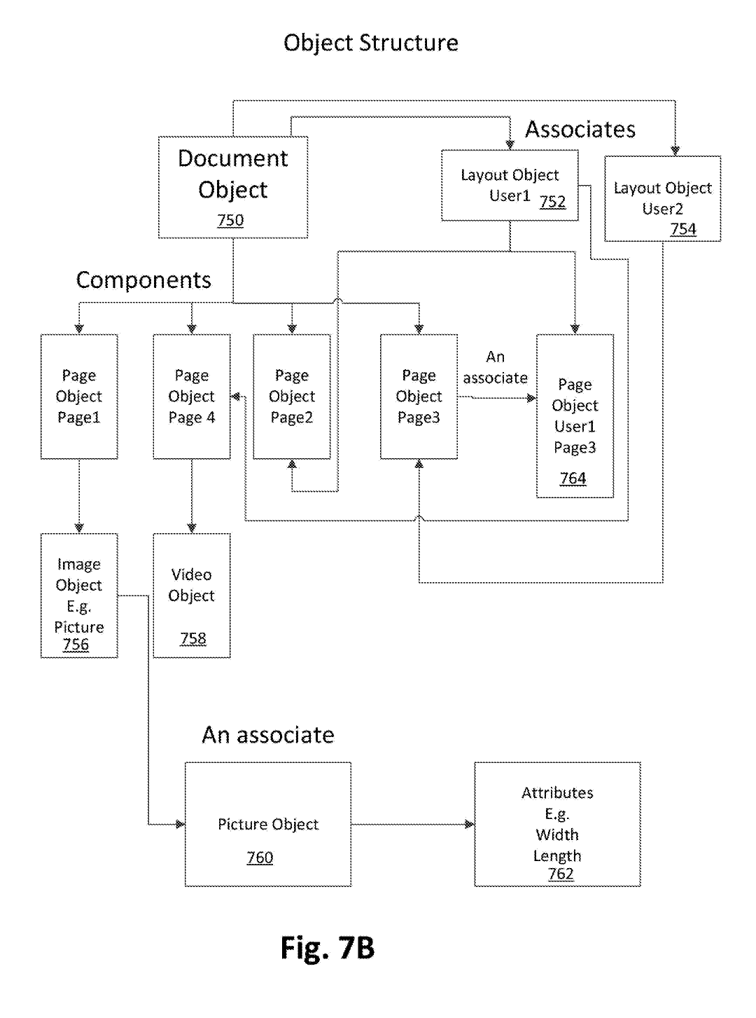

FIG. 7A shows a hierarchical view 700 of an object 701a which includes the document 601a of FIG. 6A. Primary element 704 relates to the object 701a. The object 701a has component corresponding to document 601a of FIG. 6A, indicated by sub-element 704a of FIG. 7A. Other sub elements 706 and 708 may be at the same hierarchical level of 704a, which are not discussed herein. The sub-element 704a of FIG. 7A has further sub-elements 712, 718 and 714 corresponding to component objects 612, 618 and 614 of the document 601a of FIG. 6A respectively. Fields of the objects include user permissions, as shown in FIG. 7A.

FIG. 7B shows a general example of object structure and association with a Layout. A document 750 comprises 4 object components—page1, page2, page3 and page4. A further page, 764, is associated with page 3 of FIG. 7B. The page 764 of FIG. 7B relates to user1 only. A Layout object 752 of FIG. 7B is associated with the object 750 for user1, whereas a Layout object 754 of FIG. 7B is associated with the object 750 for user2. When user1 accesses the server 177, the initial Layout rendered for user1's credentials will comprise page 2, page 4 and associated object 764. When user2 accesses the server 177, the initial Layout rendered for user2's credentials will comprise the object page3 of FIG. 7B (not the object 764). Pages may therefore have more than one type of relationship with a document or object. Firstly, a page object may be a component of a document or publication (e.g., page1-page4 are components of the object 750). Additionally, page2-page4 and the object 764 are also associated with the Layouts 754 and 754 of the object 750 of FIG. 7B.

FIG. 7B also shows that components page1 and page4 may also comprise components such as an image object 756 and video object 758 respectively. Associations of the object 756 may include an object such as the actual picture 760. The object 760 may further have attribute such as those related to width and length, as shown in object 762.

The system 200 of FIG. 2A thus provides a means for a standard computer user to create and/or manipulate any type of document, whether web page, correspondence, spreadsheet or the like via a single application, such as the GUI interface 210 (FIG. 2A). The system 200 of FIG. 2A effectively provides a software platform (formed by the applications 133A, 133B, the database 204 and the GUI application 210) for manipulation of objects and object-based documents. The user does not require any specialist skills other than those of the standard computer user, for example for operating a browser application with GUI selection via a mouse pointer. Additionally, the user does not require in-depth knowledge of how to find or implement functionality of the application, as the menus provided from the server application 133B to the device 101 relate to the detected operation of the user.

In the examples described hereinbefore, the platform afforded by the system 200 is vested in a browser application, the GUI application 210. The software platform is not limited to a browser and can be vested in other forms, such as an application. The platform provides an advantage in that, whether in browser or application form, a single version will work across a wide variety of device and operating systems. The user can then use whatever device is convenient to them at the time, e.g., the client device 101, the tablet 178 or the smartphone 179.

The predefined messages and corresponding functions discussed herein provide a basic toolkit from which a large number of applications may be built, and reflects real-world provision of tools for a task. For example, interaction may define functionality similar to a pen. Traditional word-processing tools may only allow the pen to be used on a page in a certain manner, e.g., carriage returns and tabs may be needed to place text in the middle of a page. The system for manipulation of a document described herein does not provide such restriction, but allows text to be placed wherever a user likes, similar to a pen and paper.

The client device 101 is not required to store functionality or execute unnecessary functions. Required functionality is stored on the server 177, and only stored temporarily on the client device 101 in the buffer 215 of FIG. 2A (as at step 332 of FIG. 3A) once required. The client device 101 therefore only receives functionality which must be executed locally, all other operations are executed at the server 177.

The object-oriented approach to documents used herein differs from traditional object-oriented programming as functions are not designated as objects, rather the objects relate to data in a similar fashion to “real-world” objects.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A system for manipulation of an object-based document by a user at a client device, said system comprising:
at least one server computer comprising:
a library of predefined executable functions;
a database for storage of objects associated with the document;
a guard application executable to apply at least one access permission to at least part of the document, the at least one access permission being associated with a creator of the document; and
a server application executable to:
receive a message call from the client device;
select at least one executable function from the library associated with the message call; and
communicate the selected at least one executable function to the client device;
a manipulation application executable persistently in association with a graphical user interface (GUI) application executable on the client device, by which an initial representation of the object-based document is formed in a graphical user interface of the GUI application, the manipulation application comprising :
a detection process configured to:
detect an operation of the user in association with an object of the initial representation via the GUI;
select at least one message from a plurality of predefined messages in response to the detected user operation; and
communicate the at least one message as a message call to the at least one server computer; and
a manipulation process configured to:
execute the at least one executable function received from the at least one server computer to manipulate at least one of content or presentation of the object of the initial representation to form an updated representation associated with a corresponding updated object-based document;
store the updated document at least at the client device for further access by the user; and
subject to a relationship defined by the at least one access permission between the user and the creator, store the updated document at the at least one server computer, with the objects of the document being stored in the database, for access by at least one of the user and the creator.

2. The system according to claim 1, wherein the user is the creator.

3. The system according to claim 1, wherein execution of the at least one executable function presents a transient menu within the GUI.

4. The system according to claim 3, wherein the detection process is configured to detect an operation of the user with the transient menu, and to select the at least one message in response to the detected user operation.

5. The system according to claim 1, wherein the updated document is stored as a plurality of objects, each object including at least one attribute associated with at least the updated document.

6. The system according to claim 5, wherein each object further includes at least one attribute associated with at least one of the creator and the user.

7. The system according to claim 5, wherein each object further includes at least one attribute defining the access permission relationship between the creator and the user applied by the guard application.

8. The system according to claim 1, wherein the access permission permits storing of the updated document at the at least one server computer for access by any user in communication with the at least one server computer.

9. The system according to claim 1, wherein each of the plurality of predefined messages corresponds to one of the library of predefined executable functions.

10. The system according to claim 1, wherein the document comprises a plurality of objects and each object of the plurality references at least one other object in the plurality in a hierarchical document structure.

11. The system according to claim 1, wherein the server application is executable to:
attempt to execute the selected at least one function associated with the message call;
after attempting to execute the at least one selected function, whether successful or not, deliver a response to the client device; and
where required, communicate the at least one selected function to the client device.

12. A system for manipulation of objects by a user at a client device, said system comprising:
at least one server computer comprising:
a library of predefined executable functions;
a database for storage of objects;
a guard application executable to apply at least one access permission to at least the object, the at least one access permission being associated with a creator of the object; and
a server application executable to:
receive a message call from the client device associated with the object;
select at least one executable function from the library associated with the message call; and
communicate the selected at least one executable function to the client device;
a manipulation application executable in association with a graphical user interface (GUI) application executable on the client device, by which an initial representation of at least one object is formed in a graphical user interface of the GUI application, the manipulation application comprising :
a detection process configured to:
detect an operation of the user in association with an object of the initial representation via the GUI;
select at least one message from a plurality of predefined messages in response to the detected user operation; and
communicate the at least one message as a message call to the at least one server computer; and
a manipulation process configured to:
execute the at least one executable function to manipulate at least one of content or presentation of the object to form an updated representation of the object; and
subject to a relationship defined by the at least one access permission between the user and the creator, store the updated object at the at least one server computer, the updated object being stored in the database, for access by at least one of the user and the creator.

13. The system according to claim 12, wherein the server application is executable to:
attempt to execute the selected at least one function associated with the message call; after attempting to execute the at least one selected function, whether successful or not, deliver a response to the client device; and
if, required, communicate the at least one selected function to the client device.

14. A system for manipulation of an object-based document by a user at a client device, said system comprising:
at least one server computer comprising:
a library of predefined executable functions;
a database for storage of objects associated with the document;
a guard application executable to apply at least one access permission to at least part of the document, the at least one access permission being associated with a creator of the document; and
a server application executable to:
receive a message call from the client device;
select at least one executable function from the library associated with the message call; and
communicate the selected at least one executable function to the client device;
a manipulation application executable persistently in association with a graphical user interface (GUI) application executable on the client device, by which an initial representation of the object-based document is formed in a graphical user interface of the GUI application, the manipulation application comprising :
a detection process configured to:
detect an operation of the user in association with an object of the initial representation via the GUI;
select at least one message from a plurality of predefined messages in response to the detected user operation;
check if functionality associated with the at least one message is available at the client device; and
if the functionality associated with the at least one message is available at the client device, communicate the at least one message as a message call to the at least one server computer; and
a manipulation process configured to:
if the functionality associated with the at least one message is available at the client device, execute the functionality available at the client device to manipulate at least one of content or presentation of the object of the initial representation to form an updated representation associated with a corresponding updated object-based document;
if the functionality associated with the at least one message is not available at the client device, execute the at least one executable function received from the at least one server computer to manipulate at least one of content or presentation of the object of the initial representation to form an updated representation associated with a corresponding updated object-based document, and store the at least one executable function received from the at least one server computer on the client device;
store the updated document at least at the client device for further access by the user; and
subject to a relationship defined by the at least one access permission between the user and the creator, store the updated document at the at least one server computer, with the objects of the document being stored in the database, for access by at least one of the user and the creator.

15. A client device for manipulation of an object-based document, the client device comprising:
a processor;
a memory;
a graphical user interface (GUI) application stored on the memory and executable on the processor to establish communication with at least one server computer, the at least one server computer comprising:
a library of predefined executable functions;
a database for storage of objects associated with the document;
a guard application executable to apply at least one access permission to at least part of the document, the at least one access permission being associated with a creator of the document; and
a server application executable to:
receive a message call from the client device;
select at least one executable function from the library associated with the received message call; and
communicate the selected at least one executable function to the client device;
a manipulation process executable persistently in association with the GUI application on the processor, by which an initial representation of the object-based document is formed in a graphical user interface (GUI) of the GUI application, the manipulation application comprising :
a detection process configured to:
detect an operation of a user in association with an object of the initial representation via the GUI;
select at least one message from a plurality of predefined messages in response to the detected user operation; and
communicate the selected at least one message as a message call to the at least one server computer; and
a manipulation process configured to:
execute the at least one executable function received from the at least one server computer to manipulate at least one of content or presentation of the object of the initial representation to form an updated representation associated with a corresponding updated object-based document;
store the updated document at least at the memory for further access by the user; and
subject to a relationship defined by the at least one access permission between the user and the creator, store the updated document at the database of the at least one server computer, with the objects of the updated document being stored in the database, for access by at least the user.

16. A server computer, comprising:
a processor;
a memory;
a library of predefined executable functions;
a database for storage of objects associated with a document;
a server application executable on the processor to establish communication with at least one client device, and to:
receive a message call from a client device in communication with the server computer;
select at least one executable function from the library associated with the message call; and
communicate the selected at least one executable function to the client device; wherein
the server application comprises a guard application executable to apply at least one access permission to at least part of the document, the at least one access permission being associated with a creator of the document;
the at least one client device comprises a manipulation process executable persistently in association with a graphical user interface (GUI) application on the at least one client device, by which an initial representation of the object-based document is formed in a graphical user interface (GUI) of the GUI application, the manipulation application comprising :
a detection process configured to:
detect an operation of a user in association with an object of the initial representation via the GUI;
select at least one message from a plurality of predefined messages in response to the detected user operation; and
communicate the at least one message as a message call to the server computer; and
a manipulation process configured to:
execute the at least one executable function received from the server computer to manipulate at least one of content or presentation of the object of the initial representation to form an updated representation associated with a corresponding updated object-based document; and
subject to a relationship defined by the at least one access permission between the user and the creator, store the updated document at the database of the server computer, with the objects of the updated document being stored in the database, for access by at least the user.

17. The invention according to claim 15 or claim 16, wherein the updated document is stored at the database, and the objects of the updated document are stored in the database, for access by at least the user and the creator.

18. A system for manipulation of an object-based document by a user at a client device, said system comprising:
at least one server computer comprising:
a plurality of executable functions;
a guard application executable to apply at least one access permission to at least part of the document; and
a server application executable to:
communicate at least one executable function of the plurality of executable functions to the client device;
a manipulation application, executable in association with a graphical user interface (GUI) application executable on the client device, by which an initial representation of the object-based document is formed in a graphical user interface of the GUI application, the manipulation application being operable to:
detect an operation of the user in association with an object of the initial representation via the GUI;
communicate with the at least one server computer to receive the at least one executable function based upon the detected operation;
execute the at least one executable function received from the at least one server computer to manipulate presentation of the object of the initial representation to form an updated representation associated with a corresponding updated object-based document; and
subject to the at least one access permission, store the updated document at least at one of the client device and the at least one server computer for further access by at least the user.
